(19) United States
(12) Patent Application Publication
(10) Pub. No.: US 2007/0220073 A1
(43) Pub. Date: Sep. 20, 2007

(54) Digital filter and method for designing digital filters

(76) Inventor: Mario Traber, Deisenhofen (DE)

Correspondence Address: JENKINS, WILSON, TAYLOR & HUNT, P. A., 3100 TOWER BLVD, SUITE 1200, DURHAM, NC, 27707, US

(21) Appl. No.: 11/545,838

(22) Filed: Oct. 11, 2006

(30) Foreign Application Priority Data
Oct. 12, 2005 (EP) 05022259.5

(51) Int. Cl. G06F 15/00

(52) U.S. Cl. 708/200

(57) ABSTRACT

A digital filter comprises a plurality of filter units each realizing mutually independent filter functions with a predetermined recursive filter order on a signal path between the input and the output of the filter and operating at a first clock rate, a plurality of sampling devices operating at the first clock rate, and a weighting network coupled to the sampling devices and operating at a second clock rate. The filter units comprise at least one delay element which can be reset to a predeterminable value. To each of the filter units one of the sampling devices is allocated setting the respective delay element to a predetermined value dependent on a sampling rate conversion factor. An input signal is conducted, via the weighting network, to a respective sampling device, or digital internal sampling signals output by a respective sampling device are conducted to the output via the weighting network.

### BACKGROUND OF THE INVENTION

The present invention relates to a digital filter, to a method for determining filter coefficients, and to a design method for constructing digital filters.

In digital signal processing, signals must be frequently processed which have different clock frequencies on the signal processing path. For example, in DSL technologies, signals must be subjected to a sampling rate conversion in order to be forwarded from a clock domain which is operated at a baseband frequency to a further clock domain at a higher sampling frequency. Sampling rate conversions are effected by means of interpolation or decimation filters. An interpolation filter generates from a data stream with a lower sampling rate a data stream having a higher sampling rate, wherein intermediate values are determined from the input signal and are output as output bit stream with a high sampling rate. In this process, the signal is filtered in accordance with a filter function of the interpolation filter. Decimation filters generate from a signal with a high sampling rate an output signal with a lower sampling rate by filtering with a filter function. The ratio of the sampling rate of the input signal to the output signal is called the sampling rate conversion factor.

Achieving a predetermined filter function for a corresponding interpolation or decimation filter requires as a rule many filter stages which, connected in cascade, perform a number of sampling rate conversions and filterings. This sampling rate conversion, which is normal according to the prior art, is required since the various filters of the filter stages are only efficient in certain frequency bands. In the case of up-sampling, for example, that is to say an interpolation of the input signal from a baseband processor to a processor having a higher sampling rate, an FIR filter, a wave digital filter and, for example, a comb filter are provided on the signal path. These filters have, for example, chains of delay elements with feedback as integrator stages.

When such integrator stages are connected in cascade in interpolation or in decimation filters, the bit width is in each case increased due to the integration process which necessitates disadvantageously wider memories for the delay elements. For the simple case of a second-order comb filter function, therefore, a decimation filter in which a necessary signal bit width is limited by resetting registers used as delay elements was proposed in “Voiceband Codec with Digital Filtering”, Candy et al., in IEEE Transactions on Communications Vol. com. -29, No. 6, June 1981. In order to achieve the filter characteristic required in the document, however further fourth-order low-pass filters and second-order high-pass filters are required on a signal path from a high to a low sampling rate.

In order to be able to use signal processing processors today in a flexible manner however, flexible adaptation of the filter characteristic with a predetermined filter function or impulse response function is required, on the one hand, and the computing and storage complexity should be as low as possible. A disadvantage of integrator stages of delay elements with feedback also consists in that quantization errors occurring always propagate due to the integration and cannot be corrected.

### BRIEF SUMMARY OF THE INVENTION

In one aspect of the invention, a digital filter for converting a digital input signal into a digital output signal having in each case a different sampling rate is provided, the filter comprising:

a) a digital filter for converting a digital input signal into a digital output signal having in each case a different sampling rate, with a number of filter units which implement in each case mutually independent filter functions with a predetermined recursive filter order on a signal path between an input and an output of the digital filter, wherein each filter unit has at least one delay element which can be reset to a predeterminable value,

b) wherein to each filter unit, a sampling device is allocated which sets at least one resettable delay element to a predetermined value in dependence on a sampling rate conversion factor N,

c) with a weighting network, coupled to the sampling devices, with weighting coefficients, wherein the digital input signal is conducted via the weighting network to a respective sampling device or wherein digital internal sampling signals output by a respective sampling device are conducted to the output of the digital filter via the weighting network, and

d) wherein the filter units and the sampling devices are operated at a first clock rate and the weighting network is operated at a second clock rate.

One aspect forming the basis of the invention consists in assembling a desired filter function of the digital filter from mutually independent filter functions of the filter units. Resetting these filter units prevents, on the one hand, quantization errors from propagating over a large number of clock periods and, on the other hand, a bit width of the signal produced during the processing from increasing considerably. The inventive digital filter is constructed in such a manner that both an interpolation with an interpolation factor can be effected if the input signal is supplied to the sampling devices via the weighting network, and a decimation filter with a decimation factor N can be formed wherein the input signal is first conducted through the filter units and then is coupled via the sampling devices into the weighting network which then determines the decimated output signal.

In the inventive digital filter, the weighting network is operated at the higher sampling rate or clock frequency and the filter units which, as a rule, have storage or delay devices, are operated at the lower sampling or clock rate. The inventive digital filter especially has the advantage that arbitrary target impulse response functions can be achieved by selecting the weighting coefficients. To achieve a predetermined interpolation or decimation factor, it is therefore no longer necessary to have a number of filters and converters but only one inventive digital filter with a clock domain of the first clock rate and a clock domain of the second clock rate. In the case of a parallel arrangement of the inventive filter, the respective signals generated by the weighting network can also be determined or calculated simultaneously and then provided for the respective interpolation or decimation taps.

The filter units may preferably have filter functions which are mutually orthogonal. For example, a respective filter unit can implement a Chebyschev, Butterworth or Bessel filter function of the respective predetermined order.

In a particularly preferred manner, at least one filter unit may be constructed as integrate-and-dump filter. In principle, the inventive filter can be arranged with all possible filter units which have impulse response functions which allow a predetermined target impulse response function to be approximated by a linear combination. Integrate-and-dump filters have the advantage that a corresponding filter unit is in each case reset to a predetermined value which can be, for example, zero, or to a value which is conducted to the sampling device by the weighting network.

In a preferred embodiment, a filter unit constructed as integrate-and-dump filter may comprise a filter function or an impulse response function according to

$${H}_{DI}^{k , N} ( z ) = {\sum }_{n = 0}^{N - 1} ( \begin{matrix}n + k - 1 \\ K - 1\end{matrix} ) {z}^{- n} ,$$

where K is the recursive order of the filter unit and N is the respective sampling rate conversion factor.

In a further embodiment, a respective filter unit may have a number of resettable delay elements corresponding to the predetermined recursive order, which are interconnected with feedback to form an integrator device. In this arrangement, a respective associated sampling device generates a reset signal for the delay elements. In the arrangement as decimation filter, this reset signal can be a reset or a set-to-zero signal, or in the case of interpolation filters it can be a precharge signal, the value of which is predetermined by the weighting network. The output signal of the digital filter is then formed as the sum of the output signals of the filter unit connected as integrator device.

In a further embodiment, a respective filter unit may have exactly one delay element with feedback. In this case, the integrated delay elements with feedback with their associated sampling devices can be considered in each case as integrate-and-dump filter.

The filter units may be combined to form an integrator stage. A number of resettable delay elements with individual feedback are provided therein, corresponding to a maximum predetermined recursive order of the filter according to the invention. A respective associated sampling device is coupled to an input of a respective delay element with feedback and is set to a precharge value or reset to zero by the sampling device.

The output of each resettable delay element with feedback of the integrator stage may be followed by a shifting device. This shifting device shifts a respective digital signal by a predetermined number of bits. The result is that the bit width increased by the respective integration by a delay element with feedback is initially reduced. The dynamic range of the respective integrate-and-dump filter chain in the integrator stage is thus reduced. The shifting devices also reduce the requirements for the accuracy or quantization of the weighting coefficients. This reduces the number of bits needed for representing the weighting coefficients.

The inventive digital filter may be in the form of an interpolation filter, wherein the weighting network has a delay element chain, coupled to the input of the filter, of series-connected delay elements, wherein delayed internal signals can be picked up at nodes of the delay element chain, and wherein the weighting network generates precharge signals for the sampling devices in such a manner that a respective precharge signal corresponds to the sum of the delayed internal signals weighted with weighting coefficients.

Accordingly, the weighting network accepts input signals delayed by a delay factor in each case and forms from these in each case linear combinations which are represented by the respective precharge signals.

The resettable delay elements may then preferably be reset to a value corresponding to the precharge signal with each Nth clock pulse by the associated sampling device.

The digital filter may be in the form of a decimation filter, wherein the weighting network has a delay element chain, coupled to the output of the filter, of series-connected delay elements, wherein nodes are provided between the delay elements of the delay element chain, and wherein the weighting network generates segment signals for the nodes of the delay element chain in such a manner that a respective segment signal corresponds to a sum of the internal sampling signals weighted with weighting coefficients.

The structure of the weighting network essentially corresponds to the embodiment used in the interpolation, wherein, in particular, the weighting coefficients may be the same in principle. The segment signals correspond to linear combinations of the signals provided by the filter units and gated by the respective sampling device.

In this embodiment, the resettable delay elements are in each case preferably reset to zero by the associated sampling device with an Nth clock pulse.

The delay element chain may preferably have a number of delay elements which corresponds to a maximum predetermined recursive filter order. Thus, a quadratic matrix of weighting coefficients is needed for the weighting network. In principle, however, an embodiment with fewer delay elements is also possible as a result of which the weighting coefficient matrix is smaller.

To each working coefficient which is not equal to zero, a multiplier and an adder may preferably be allocated. The respective multiplier weights a corresponding signal in the weighting network with the weighting coefficient and the respective adder is used for achieving a respective sum in the above-mentioned linear combination.

In a further embodiment of the inventive filter, the output of each filter unit is followed by a shifting device which in each case shifts a digital signal by a predetermined number of bits. This shifting is used for limiting or reducing the bit width of the weighting coefficients and reducing the dynamic range of the filter units, i.e. limiting the respective necessary bit widths of the output signals of the filter units.

The number N of sampling devices may preferably correspond to a predetermined approximation filter order by means of which the digital filter achieves a target filter function.

The inventive digital filter may approximate a target filter function with a length of L interpolation points, wherein the number S of the series-connected delay elements of the delay element chain is

$$S = [ \frac{L}{N} ] ,$$

where S is given by rounding up L/N, that is to say the next higher integral number to L/N.

In this manner, a predetermined target filter function is approximated segment by segment, wherein each segment is defined by a set of weighting coefficients. This results in filter orders S (N−1).

The inventive filter may have a symmetric FIR filter function, wherein further filter units coupled to the weighting network via further sampling devices are provided. With a symmetric impulse response function, the symmetry can be preferably utilized as a result of which the number of necessary weighting coefficients can be halved compared with an arbitrary filter function. As a result, the implementation expenditure also becomes considerably lower.

The weighting network may then preferably generate further precharge signals for the further sampling devices in such a manner that a respective further precharge signal corresponds to a sum of the delayed internal signals weighted with weighting coefficients, wherein a respective weighted delayed internal signal is delayed in dependence on the delay of the internal delayed signal before the summation. In this symmetric embodiment of an interpolation filter according to the invention, a segment of the predetermined symmetric target filter function which has already been approximated is achieved mirrored due to the delay of the internal signals.

In an alternative embodiment of the interpolation filter, a further delay element chain with series-interconnected delay elements may be allocated to each further sampling device wherein a respective further precharge signal can be picked up at the delay element chain. In this arrangement, an internal delay signal weighted with a respective weighting coefficient is supplied to the input of each delay element of the respective further delay element chain. This alternative generation of the further precharge signals also leads to a reuse of weighting coefficients already determined, in order to generate a symmetric segment of the target impulse response function.

The further sampling devices may preferably be coupled to a further integrator stage, the output of which is followed by a time reverser. Furthermore, an adder is preferably provided which adds the output signals in the integrator stage and outputs them as the output signal of the filter. The output signal of a symmetric interpolation filter according to the invention is, therefore, composed additively of the two signals of the integrator stage and the further integrator stage.

In an embodiment of the inventive filter, the filter constructed as decimation filter, the weighting network may generate such segment signals that a respective segment signal corresponds to a sum of the sums of the internal sampling signals, weighted with weighting coefficients, with further delayed internal sampling signals. Before the summation, a respective further internal sampling signal generated by a further sampling device is delayed in dependence on the respective node of the delay element chain.

In an alternative embodiment of the version as decimation filter, a further delay element chain with series-interconnected delay elements, which are supplied with a respective further sampling signal, may be allocated to each further sampling device. At outputs of the further delay elements, delayed internal sampling signals can be picked up and the segment signals are generated in such a manner that a respective segment signal corresponds to a sum of the sum, weighted with the weighting coefficients, of the respective internal sampling signals with the respective delayed internal sampling signals. In an embodiment as decimation filter, too, the properties of symmetry of the target impulse response function can be used for halving the number of necessary weighting coefficients.

As an alternative, in the embodiment arranged as decimation filter, a further delay element chain with series-interconnected delay elements can be allocated to each further sampling device. Each further delay element chain is then supplied with a respective further sampling signal, wherein delayed internal sampling signals can be picked up at outputs of the further delay elements. The segment signals are generated in such a manner that a respective segment signal corresponds to a sum of the sums, weighted with the weighting coefficients, of the respective internal sampling signals with the respective delayed internal sampling signals.

The further sampling devices may then preferably be coupled to a further integrator stage, the input of which is preceded by a time reverser which receives the digital input signal of the filter. The time reverser and the additional delayed further sampling signals are used for assembling mutually symmetric segments of a target impulse response function in such a manner that an approximated predetermined target impulse response function is approximated by the decimation filter according to the invention.

The delay elements of the further delay element chain may be in each case preferably set up in such a manner that a delay by z⁻² corresponding to the second clock rate is generated.

The filter preferably may have a symmetric FIR filter function and the number S of series-connected delay elements of the delay element chain is

$$S = [ \frac{L}{N} ] ,$$

where S is the value of an integral number rounded up to the next higher one with respect to L/2N.

The invention also provides a polyphase filter arrangement with a number P of filter branches with in each case one inventive digital filter, with a switching device which couples a digital polyphase filter input signal into the filter branches in each case time delayed as branch signal, and with a summing device which combines the output signals of the filters to form a polyphase filter input signal. Such a polyphase filter arrangement has the advantage that the individual digital filters can be operated at a reduced clock rate. This is preferably reduced by the factor P.

In one embodiment of the inventive polyphase filter arrangement, a weighting network which is common to the digital filters of the filter branches is provided which is operated at the second clock rate. This has the advantage that a considerable implementation expenditure is saved since the weighting network needs to be provided only once. In addition, the digital filters according to the invention for the filter branches have the advantage that they need the same weighting coefficients for the common weighting network.

Preferably, common sampling devices may then also be provided for the digital filters of the filter branches. The sampling devices are then preferably coupled via switches to the respective filter units or to the delay elements with feedback of the respective integrator devices. The common weighting network is accordingly coupled to the filter units of a filter branch, allocated to the respective filter branches, or to the respective integrator devices of the filter branches, via the sampling devices.

The inventive polyphase filter arrangement may be constructed as interpolation filter, wherein a group of P series-interconnected delay elements is allocated to each filter branch, a branch signal can be picked up in each case at nodes between the delay elements of a group, and wherein the groups are series-connected to one another at an input of the polyphase filter arrangement.

The inventive polyphase filter may be in the form of a decimation filter, wherein a group of P series-interconnected delay elements is allocated to each filter branch, the segment signals are supplied to a respective group clock pulse by clock pulse via adders provided between the delay elements, and wherein the groups are series-connected to one another at an output of the polyphase filter arrangement.

The P series-interconnected delay elements allocated to each filter branch provide for the corresponding signal phase for the respective filter branch.

The invention also provides a method for determining filter coefficients of a digital filter which achieves a predetermined target impulse response function, comprising the steps of:

a) subdividing the target impulse response function into segments, wherein each segment s has a predetermined number of interpolation points, and wherein a set of weighting coefficients is allocated to each segment s,

b) determining independent setup impulse response functions which in each case have a recursive filter order k and depend on a sampling rate conversion factor N,

c) forming a linear combination of the setup impulse response functions for each segment s, wherein the coefficients of the linear combination correspond to the weighting coefficients of the respective segment s and wherein the weighting coefficients C_{s,k} are selected in such a manner that the linear combination approximates the target impulse response function in the respective segment.

Possible setup impulse response functions to be considered are, for example, Chebyschev polynomials, Butterworth or Bessel filter functions. The weighting coefficients are preferably determined by means of a balancing calculation, particularly by interpolations. A method of the least square deviations can preferably also be used for this purpose.

The setup impulse response functions in each case may correspond to an integrate-and-dump filter having a recursive order k and a reset period of N. Advantageous independent setup impulse response functions are, for example,

$${H}_{DI}^{K , N} ( z ) = {\sum }_{n = 0}^{N - 1} ( \begin{matrix}n + K - 1 \\ K - 1\end{matrix} ) {z}^{- 1} ,$$

where K corresponds to a predetermined maximum recursive filter order.

The target impulse response function preferably has a length L and the number S of segments is

$$S = [ \frac{L}{N} ]$$

The number of interpolation points or the length of the respective segment, respectively, may correspond to the sampling rate conversion factor N. If necessary, other interpolation points of the target impulse response function, which are set to zero, can also be added in order to provide exactly N interpolation points or taps for each segment.

The number of segments may be equal to a predetermined maximum recursive filter order K.

The weighting coefficients may be determined from a system of equations

$${\underbrace{( \begin{matrix}{h}_{e \cdot N + 0} \\ {h}_{e \cdot N + 1} \\ ⋮ \\ {h}_{e \cdot N + N - 1}\end{matrix} )}}_{\underline{h}} = {\underbrace{( \begin{matrix}{w}_{0 , 1} & {w}_{0 , 2} & ⋯ & {w}_{0 , K} \\ {w}_{1 , 1} & {w}_{1 , 2} & ⋯ & {w}_{1 , K} \\ ⋮ & ⋮ & ⋰ & ⋮ \\ {w}_{N - 1 , 1} & {w}_{N - 1 , 2} & ⋯ & {w}_{N - 1 , K}\end{matrix} )}}_{\underline{w}} \cdot \underbrace{( \begin{matrix}{C}_{e , 0} \\ {C}_{e , 1} \\ ⋮ \\ {C}_{e , K - 1}\end{matrix} )}$$

where h represents an interpolation point vector, c represents a weighting coefficient vector and W represents a setup impulse response matrix. The following applies: W_{n,k}=(_{K-1}^{n+k-1}).

This system of equations represented in matrix form can then be solved in approximation by means of known methods, for example by means of least square errors.

The target impulse response function may be selected to be symmetric and the weighting coefficients are determined in such a manner that one pair of weighting coefficients in each case has the same value. A symmetric target impulse response function enables the number of various weighting coefficients to be halved compared with an arbitrary asymmetric target impulse response function.

In a matrix-shaped arrangement of the weighting coefficients, a matrix is thus obtained which has an even number of columns, wherein the entries are symmetric with respect to a perpendicular centre axis. In a particularly preferred manner, the method determines the weighting coefficients for a digital filter according to the invention, wherein the filter units have filter functions proportional to the setup impulse response functions and wherein a respective delayed internal signal or a respective segment signal is allocated to a segment S.

In addition, the invention provides a method for designing a digital filter according to the invention, comprising the steps of:

a) determining a target impulse response function, a maximum recursive filter order K, the sampling rate conversion factor N and a number of segments S;

b) determining the weighting coefficients in accordance with the method according to the invention detailed above;

c) forming a digital filter with the weighting network, wherein a multiplier and an adder is provided for each weighting coefficient which is not equal to zero, and wherein filter units implementing the setup impulse response functions are in each case provided.

The maximum recursive filter order may preferably be selected in such a manner that the maximum deviation of the implemented filter impulse response function from the target impulse response function is below a predetermined tolerance threshold.

An advantageous embodiment of the design method furthermore may provide for step b) for at least one segment:

a) determining a trial set of weighting coefficients in which at least one of the K weighting coefficients is set to zero,

b) determining the weighting coefficients of the set of trial weighting coefficients which are not to zero in such a manner that the linear combination approximates the target impulse response function (H_{IAF}(Z)) in the respective segment,

c) determining a respective maximum deviation of the filter impulse response function implemented by means of the trial set of weighting coefficients, from the target impulse response function in the segment s.

This embodiment provides the advantage that trial sets of weighting coefficients are determined in which some weighting coefficients are zero. It is possible, therefore, to omit the adder and multiplier in constructing the digital filter which means a lower implementation expenditure.

Trial sets of weighting coefficients may preferably be determined and the respective maximum deviation is determined for all combinations of weighting coefficients set to zero. For each segment s with, for example, k associated weighting coefficients, k! sets of trial weighting coefficients must therefore be evaluated.

For implementing the weighting network, those trial sets of weighting coefficients may preferably be selected which have the highest number of weighting coefficients set to zero, the maximum deviations being below a predetermined tolerance threshold.

Although, as a result, extensive calculations for evaluating the sets of trial weighting coefficients are initially performed during the design, the method provides, for the respective implementation, very advantageous sets of weighting coefficients which have as many weighting coefficients as possible which are zero. The slightly increased expenditure in computing power for the design method is thus balanced by a digital filter with particularly advantageous expenditure.

The inventive filter may preferably be hard wired or implemented on a computer, for example by means of a programmable digital signal processor. The method according to the invention for determining the filter coefficients is preferably implemented as computer program and stored on a storage medium, for example a diskette. This computer program product then causes a programmable computer to carry out the determining process.

### BRIEF DESCRIPTION OF THE SEVERAL VIEWS OF THE DRAWINGS

In the text which follows, the invention is explained in greater detail by means of illustrative embodiments, referring to the attached figures, in which:

FIG. 1 is a first exemplary embodiment of an interpolation filter.

FIG. 2 is a first- and second-order integrate-and-dump filter.

FIG. 3 is a second exemplary embodiment of an interpolation filter.

FIG. 4 is a third exemplary embodiment of an interpolation filter.

FIG. 5 is a fourth exemplary embodiment of an interpolation filter.

FIG. 6 is an alternative embodiment of an integrator stage.

FIG. 7 is a first exemplary embodiment of a decimation filter.

FIG. 8 is a second exemplary embodiment of a decimation filter.

FIG. 9 is a segmented target impulse response function.

FIG. 10 are curves of maximum errors of impulse response functions implemented by filters.

FIG. 11 is the frequency response of the filter according to the invention compared with the target filter functions.

FIG. 12 is an impulse response function.

FIG. 13 are frequency responses of target filter functions and impulse response functions implemented.

FIG. 14 is a balanced target impulse response function.

FIG. 15 is a first exemplary embodiment of a symmetric arrangement of an exemplary embodiment of an interpolation filter.

FIG. 16 is an alternative embodiment of a symmetric interpolation filter.

FIG. 17 is a symmetric arrangement of a decimation filter.

FIG. 18 is a polyphase arrangement of an interpolation filter.

FIG. 19 is a polyphase arrangement of a decimation filter.

FIG. 20 is an illustrative embodiment of a further polyphase interpolation filter.

FIG. 21 is an exemplary embodiment of another polyphase decimation filter.

FIG. 22 are impulse response functions and frequency responses of a polyphase filter.

FIG. 23 is a comb filter impulse response function.

FIG. 24 is a further exemplary embodiment of an interpolation filter with shifting devices.

### DETAILED DESCRIPTION OF THE INVENTION

In the figures, identical or functionally identical elements have been provided with the same reference numbers unless otherwise specified.

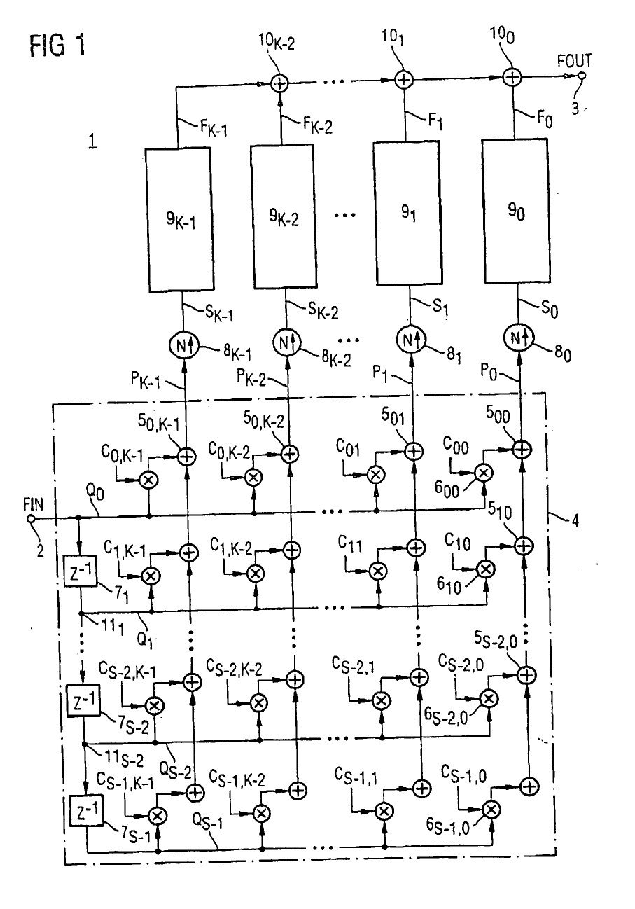

FIG. 1 shows in a general form a digital filter 1 according to the invention arranged as interpolation filter.

The digital filter 1 has an input 2 for receiving a digital input signal FIN and an output 3 for outputting a filtered digital output signal FOUT. The input 2 is coupled to a weighting network 4 which has a matrix of adders 5ᵢⱼ and multipliers 6ᵢⱼ, the multipliers in each case being supplied with weighting coefficients Cᵢⱼ where i=0 to S−1 and j=0 to K−1. K corresponds to the filter order of the interpolation filter 1 and S designates the number of segments into which a target impulse response function of the filter which was previously selected was split up. Splitting into segments and implementation by means of the filter 1 according to the invention will be explained in greater detail in the text which follows.

The weighting network 4 also provides a chain of delay elements 7ᵢ, with i=1 to S−1, which is coupled to the input 2. The weighting network 4 delivers precharge signals Pⱼ, with j=0 to K−1, to sampling or gating devices 8ⱼ, where the gating devices 8ⱼ generate sampling signals Fⱼ which are conducted to filter units 9ⱼ. Each filter unit 9ⱼ delivers an output signal Fⱼ which is added to the output signal FOUT via the adder 10ⱼ.

The filter units 9ⱼ in each case have a filter function of a predetermined recursive filter order, wherein the filter unit 9₀ is of the first order, the filter unit 9₁ is of the second order etc., up to filter unit 9_{K-1} which has a filter function of Kth order.

The weighting network 4 is here operated at a first low clock rate and the filter units 9ⱼ are operated at a second higher clock rate. From the input signal FIN, internally delayed signals Qᵢ, with i=0 to S−1, are generated by the series-interconnected delay elements 7ᵢ and are applied to nodes 11ᵢ. The zeroed internal delayed signal Q₀ corresponds to the input signal FIN and the last internal delayed signal Q_{S-1} can be picked up at the output of the last delay element 7_{S-1}.

The weighting network 4 is arranged in such a manner that the precharge signals Pⱼ correspond to linear combinations of the delayed internal signals Qᵢ, wherein the coefficients of a respective linear combination of the weighting coefficients C_{i,j} correspond to a column of the weighting coefficients shown in matrix form in FIG. 1. With each Nth clock pulse, the respective sampling device 8ⱼ delivers the corresponding precharge signal Pⱼ as sampling signal Sⱼ to the respective filter unit 9ⱼ, and otherwise zeros. The filter units 9ⱼ in each case have an impulse response function Hⱼ(z). So-called integrate-and-dump filters have been found to be an advantageous choice for the filter units 9ⱼ.

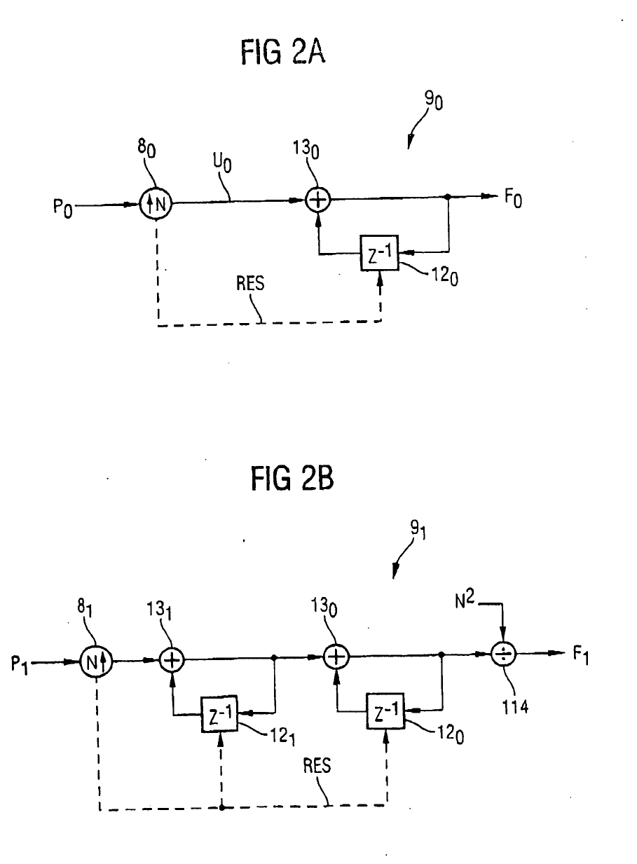

FIG. 2(A) shows a first order integrate-and-dump filter. On the signal path, a delay element 12₀ with feedback by means of an adder 13₀ is provided. The sampling device 8₀ is here provided as gating device with a gating factor N. The input signal P₀ which is present at a low sampling rate is gated by the sampling device S₀ so that a gated signal U₀ is generated which has a tap or an interpolation point having the value of the input signal P₀ present and has N−1 taps having the value 0. The integrator consisting of the adder 13₀ and the delay element 12₀ integrates this signal sequence and delivers as output signal F0 N-times the value of the input signal P₀, but with N-times the sampling rate or, respectively, with N-times the number of taps or interpolation points. After N taps, the sampling device 8₀ resets the delay element 12₀ or sets it to zero, respectively. The corresponding filter function of such a filter called first-order integrate-and-dump filter is:

$${H}_{1}^{DI} ( z ) = \frac{1 - {z}^{- N}}{1 - {z}^{- 1}} .$$

where the designation DI stands for “dump integrator”, which, in the text which follows, will be used as synonym for integrate-and-dump filter.

FIG. 2(B) shows a corresponding second-order integrate-and-dump filter which has been implemented by cascading two integrate-and-dump stages as shown in FIG. 2(A). On the signal path, two integrate-and-dump filters consisting in each case of adders 13₀, 13₁ and delay elements 12₀, 12₁ with feedback are shown, wherein the gating device 8ᵢ in each case delivers a reset signal to the delay elements 12₀, 12₁. At the output, a divider 114 is also provided which divides by a normalization factor N₂. The filter function of a corresponding second-order integrate-and-dump filter is:

$${H}_{2}^{DI} ( z ) = \frac{1 - {z}^{- N}}{{( 1 - {z}^{- 1} )}^{2}} - N \frac{{z}^{- N}}{1 - {z}^{- 1}} . \qquad ( Eq . 1 )$$

In general, the filter function of a k-th order integrate-and-dump filter, i.e. with k series-interconnected integration stages as shown in FIG. 2, can be expressed as follows:

$${H}_{DI}^{k , N} ( z ) = {\sum }_{n = 0}^{N - 1} ( \begin{matrix}n + k - 1 \\ K - 1\end{matrix} ) {z}^{- n} . \qquad ( Eq . 2 )$$

For a third-order integrate-and-dump filter with a sampling rate conversion factor of N=8, an impulse response function is obtained thus:
H_{DI}^{K-3,N-8}(z)=1+3z¹+6z²+10z⁻²+15z⁻⁴+21z⁻⁵+28z⁻⁶+36z⁷. (Eq. 3)

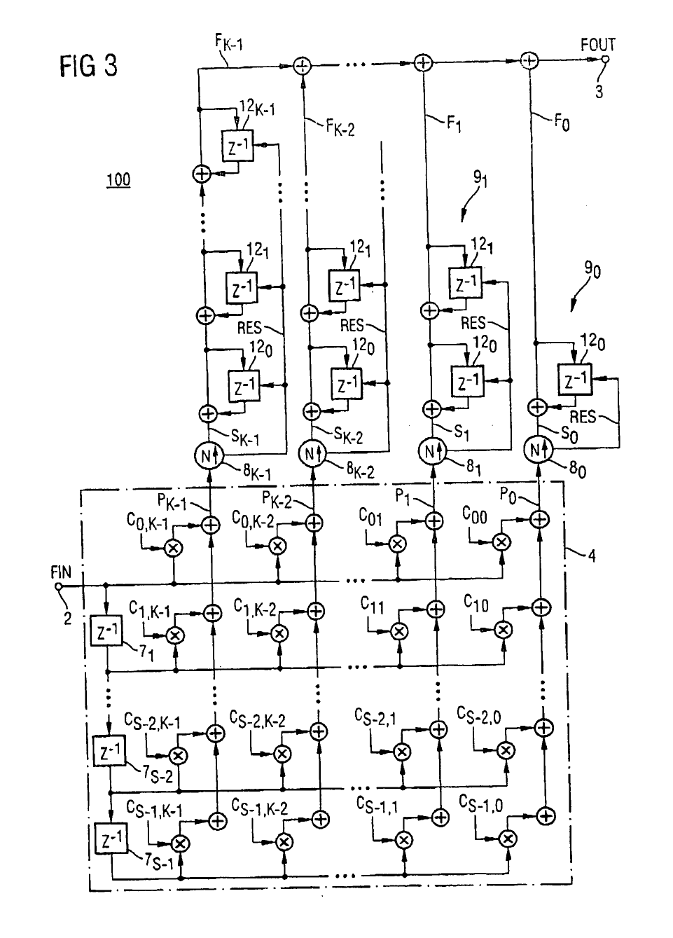

In FIG. 3, the use of such integrate-and-dump filter chains is shown as filter unit 9ⱼ, with j=0 to K−1. The structure of the interpolation filter 100 essentially corresponds to the representation from FIG. 1. The respective sampling devices 8ⱼ with j=0 to K−1, reset the series-connected delay elements 12ⱼ, with j=0 to K−1, with each Nth clock pulse of the higher clock rate at which the weighting network 4 is operated. The output signals Fⱼ with j=0 to K−1, combined as output signal F_{OUT} of the filter, of the filter units 9ⱼ can be represented as:

$${H}_{Free}^{K , N} ( z ) = \{ {P}_{0} ( z ) + [ {P}_{1} ( z ) + ( … + {P}_{N - 1} ( z ) * \frac{1}{1 - {z}^{- 1}} ) * \frac{1}{1 - {z}^{- 1}} ] * \frac{1}{1 - {z}^{1}} \} * \frac{1}{1 - {z}^{- 1}} . \qquad ( Eq . 4 )$$

Equation 4 applies as long as there is no resetting by the reset signals RES. The reset signals set the contents of the delay elements or storage elements to zero independently of the value of the sampling signals Sⱼ. The gaters only deliver values unequal to zero, namely corresponding to the precharge signal Pⱼ, on the signal path when the delay elements are reset. For this reason, the delay elements can also be advantageously set with the value of the respective precharge signal at any reset time.

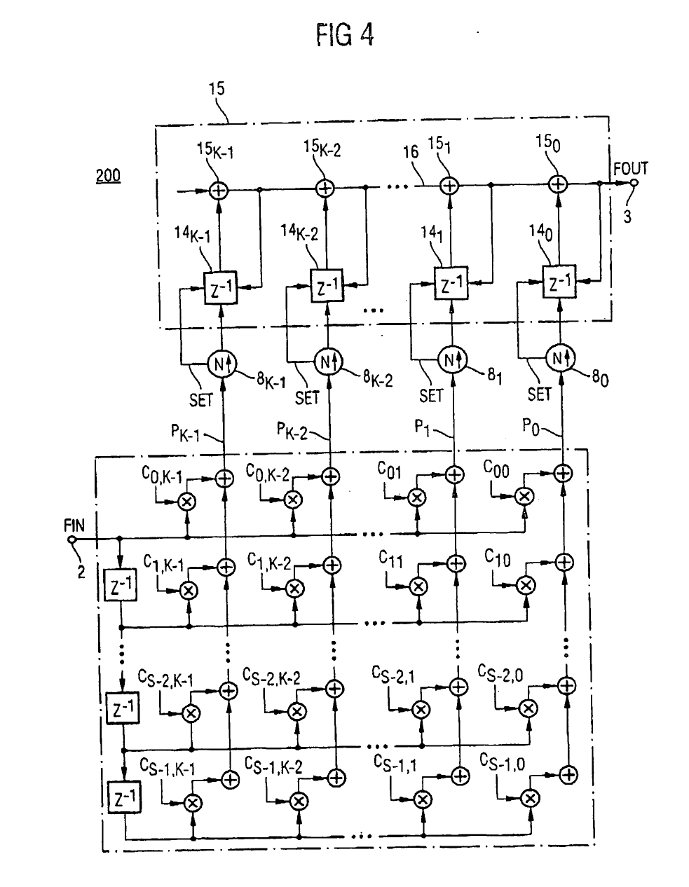

Furthermore, Equation 4 shows that the individual chains of the series-interconnected delay elements 12ⱼ can be combined to form an integrator stage which replaces the K filter units. A corresponding embodiment of the interpolation filter according to the invention based on integrate-and-dump filters is shown in FIG. 4.

The weighting network 4 corresponds to the illustrative embodiment shown in FIGS. 1 and 3, respectively. The integrator unit 15 has delay elements 14ⱼ which are coupled to the respective gating devices 8ⱼ. With each Nth clock pulse of the higher clock rate at which the sampling devices 8ⱼ and the integrator stage 15 are operated, a respective gating device 8ⱼ sets the value of the precharge signal Pⱼ present into the associated delay device 14ⱼ. The delay devices 14ⱼ are in each case coupled back via adders 15ⱼ and jointly form the output signal FOUT in an output signal branch 16.

Each delay device 14ⱼ with feedback in the integrator stage 15 delivers a contribution to the recursive order of the filter, wherein each delay element 14ⱼ can be allocated to a filter order between input 2 of the filter and output 3 of the filter. For example, the delay element 14₀ in each case delivers contributions of the first recursive order for the output signal FOUT.

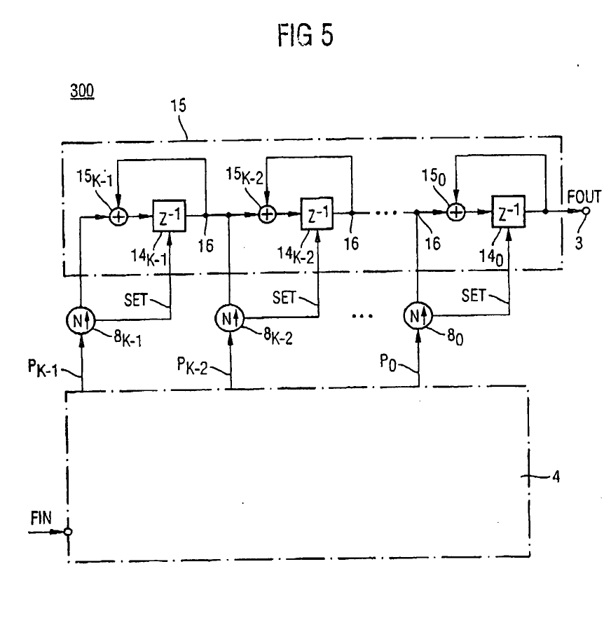

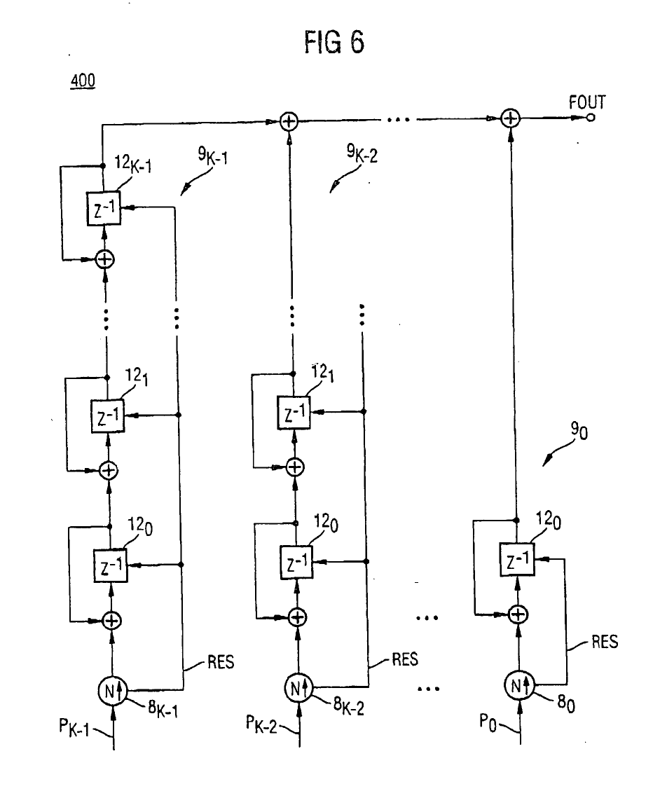

As an alternative, the delay elements 14ⱼ available in the integrator stage 15 can be arranged serially as a chain of delay elements with feedback. FIG. 5 shows a corresponding embodiment of the interpolation filter 300 according to the invention. The delay elements 14ⱼ are here in each case coupled back and interconnected in series between the output 3 of the filter and the kth gating device 8ₖ, wherein the gating devices 8ⱼ are connected in each case at node 16 between the delay elements 14ⱼ with feedback. The respective interconnected delay elements 15ⱼ with feedback as integrators in this case have an impulse response proportional to H(z)=z⁻¹/(1−z⁻¹). The chains of delay elements with feedback of the individual filter units 9ⱼ shown in FIGS. 2 and 3 can also be implemented in this form. FIG. 6 shows a corresponding alternative embodiment 400 of the filter units 9ⱼ.

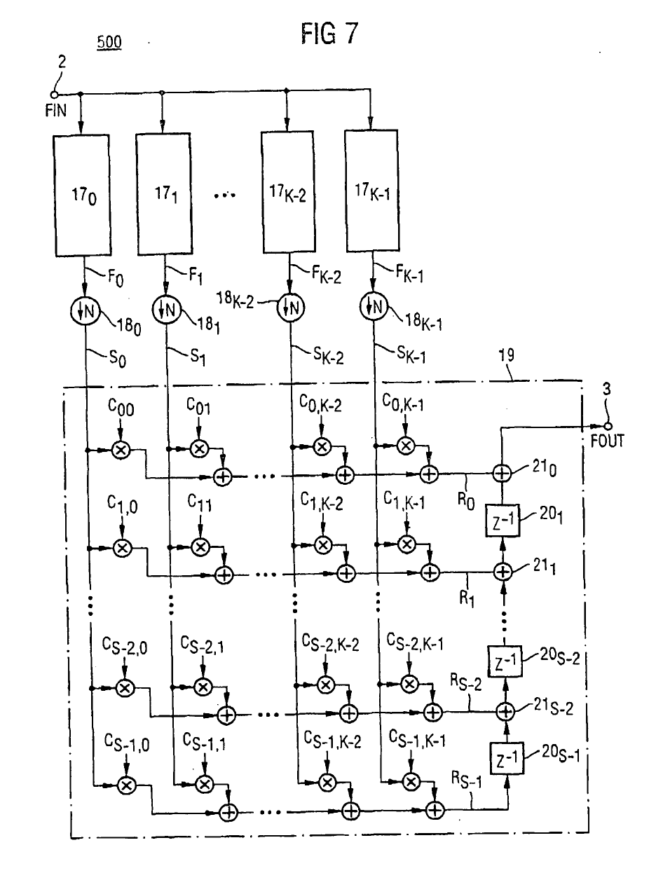

According to the invention, analogously to FIG. 1, a decimation filter can also be constructed according to the invention as shown, for example, in FIG. 7. The decimation filter 500 according to the invention has an input 2 and output 3, wherein an input signal FIN with a high sampling rate is present at the input 2 and a filtered output signal FOUT with a lower sampling rate can be picked up at output 3. The input signal FIN is in each case supplied to the filter units 17ⱼ, with j=0 to K−1, which in each case output output signals Fⱼ to a respective associated sampling device 18ⱼ.

As explained with respect to FIG. 1, the filter units 17ⱼ in each case implement a predetermined recursive filter order. The respective filter functions are preferably independent and orthogonal to one another. The respective impulse response functions of the filter units can thus be used as basic function for implementing a target impulse response function. The sampling devices 18ⱼ in each case deliver sampling signals Sⱼ to a weighting network 19.

The weighting network 19 delivers segment signals Rᵢ, with i=0 to S−1, wherein a respective segment signal represents a linear combination of the sampling signals Sⱼ. The respective coefficients of the linear combinations correspond to the weighting coefficients Cᵢⱼ. A chain of delay elements 20ᵢ, with i=1 to S−1, is connected to the output 3 of the filter. The segment signals Rᵢ, with i=1 to S−2, are coupled into the delay elements 20ᵢ via adders 21ᵢ, with i=1 to S−2, which are provided between the delay elements 20ᵢ. In this arrangement, the zeroth segment signal R₀ is coupled directly via an adder 21₀ to the output 3 of the decimation filter and the sth segment signal Rₛ₋₁ is directly coupled to an input of the last, sth delay element 20ₛ₋₁. Similar to the embodiments as interpolation filter according to FIGS. 1 to 6, therefore, an output signal FOUT with a low sampling rate is assembled from segments.

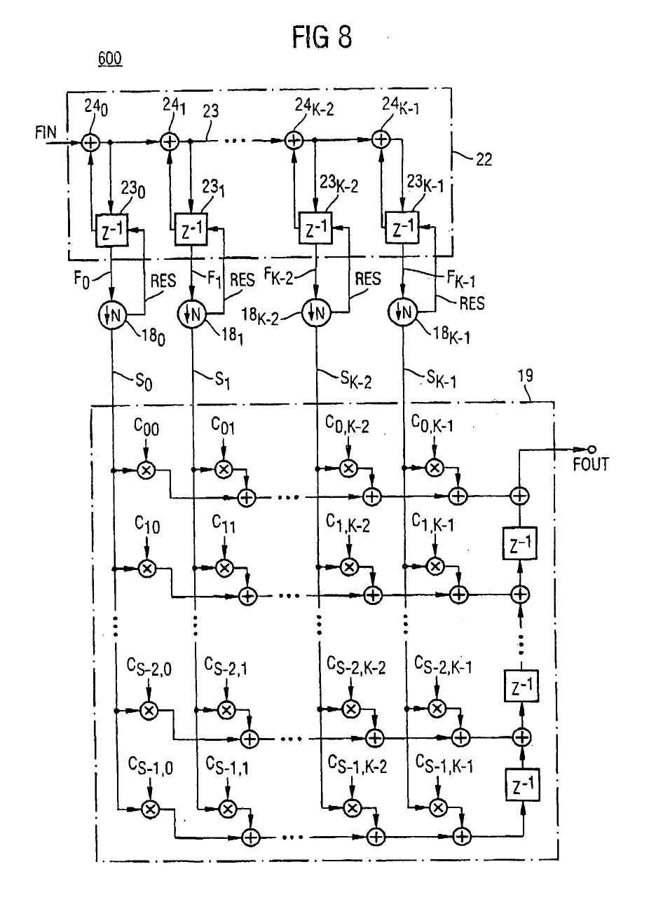

A preferred illustrative embodiment of a decimation filter according to the invention is illstrated in FIG. 8. In the decimation filter 600, the filter units are combined to form an integrator stage 22. Similar to that shown in FIG. 4 of the interpolation filter, the integrator stage 22 has delay elements 23ⱼ, with j=0 to K−1, in each case coupled back via adders 24ⱼ in an input signal branch 23. The respective delay elements 23ⱼ with feedback in each case deliver signals Fⱼ to the sampling devices 18ⱼ. With a decimation factor N, the sampling devices 18ⱼ in each case reset the respective associated delay element 23ⱼ to 0 at an Nth tap.

The respective filter transfer function or impulse response function of the filter for sampling rate conversion is mainly determined by the determination of the weighting coefficients Cᵢⱼ. The respective weighting coefficients for implementing a target impulse response function are the same for the interpolation filter or the decimation filter. The variants for the filter units or integrator devices shown in FIGS. 1 to 8 in principle in each case necessitate different matrices of weighting coefficients. However, this matrix is in each case determined in accordance with the same process. In principle, a selected target impulse response function is built up segment by segment by a linear combination of the delayed impulse response functions of the filter units. This will be explained in greater detail in the text which follows. As an example, functions according to Eq. 2 are assumed in the text which follows for the filter functions of the filter units or, respectively, the taps of the filter chains of the integrator stage.

The impulse response function H^{n,k}_{GIAD}(z), implemented by a filter according to the invention as shown in FIGS. 1 to 8 and which represents a generalized form of integrate-and-dump filters essentially depends on the choice of weighting coefficients C_{i,j}. The impulse response function can be represented as follows:

$${H}_{GIAD}^{N , K} ( z ) = \frac{1}{{N}^{K}} \cdot \underline{H} \cdot \underline{C} \cdot \underline{D} \\ \underline{H} = ( \begin{matrix}{H}_{1}^{DI} ( z ) & {H}_{2}^{DI} ( z ) & … & {H}_{K}^{DI} ( z )\end{matrix} ) \\ \underline{C} = ( \begin{matrix}{C}_{0 , 0} & {C}_{0 , 1} & … & {C}_{0 , K - 1} \\ {C}_{1 , 0} & {C}_{1 , 1} & … & {C}_{1 , K - 1} \\ ⋮ & ⋮ & ⋰ & ⋮ \\ {C}_{S - 1 , 0} & {C}_{S - 1 , 1} & … & {C}_{S - 1 , K - 1}\end{matrix} ) \\ \underline{D} = {( \begin{matrix}1 & {z}^{- N} & {z}^{- 2 N} & … & {z}^{- ( S - 1 ) N}\end{matrix} )}^{T} \qquad ( Eq . 5 )$$

where vector H contains the z transformations of the filter units or, in this case, of the integrate-and-dump filters, C corresponds to the matrix of weighting coefficients Cᵢⱼ and vector D represents the chain of delay elements 7ᵢ, with i=0 to s−1, of the weighting network 4. The sampling rate of the signals refers to the high clock frequency which is why the delays D are given to the power of the interpolation factor N. Equation 5 describes an impulse response function H_{N,K}_{GIAD}(z) which covers the S segments of length N in each case. GIAD (=generalized integrate and dump) designates the generalized integrate-and-dump filter. Each segment s generates an impulse response of an integrate-and-dump filter of length N, wherein each segment has a delay by N taps or interpolation points, respectively. A respective segment length is therefore dependent on the interpolation or decimation factor or sampling rate conversion factor N. It is now possible to specify an arbitrary target impulse response function for a conversion factor N and adapt the matrix of coefficients in Equation 5 in such a manner that the resultant impulse response function H^{N,K}_{GIAD}(z) approximates this target impulse response function as well as possible.

With a desired target impulse response function in the form of a comb filter function

$${H}_{CF}^{N , K} ( z ) = \frac{1}{{N}^{K}} {( \frac{1 - {z}^{- N}}{1 - {z}^{- 1}} )}^{K} = \frac{1}{{N}^{K}} {⊗}_{k = 0}^{K - 1} \{ {\sum }_{n = 0}^{N - 1} {z}^{- N} \} \qquad ( Eq . 6 )$$

for example, the weighting coefficients Cᵢⱼ can be precisely calculated. N is here the sampling rate conversion factor and K is the maximum recursive order of the desired filter. The length of a segment is, therefore, N, where the length of the target impulse response function for a comb filter is L=K·N−K+1=K(N−1)+1. As a rule, for practical applications, K<N−1 applies so that a quadratic matrix of weighting coefficients with S=K can be selected, that is to say S=S_{CF}^{N,K}=N in this case. For each segment s, a system of equations (Eq. 7) is thus obtained

$$\begin{matrix}( \begin{matrix}{h}_{s \cdot N - 0}^{CF} \\ {h}_{s \cdot N - 1}^{CF} \\ ⋮ \\ {h}_{s \cdot N - N - 1}^{CF}\end{matrix} ) = \underbrace{( \begin{matrix}{w}_{0 , 1} & {w}_{0 , 2} & ⋯ & {w}_{0 , K} \\ {w}_{1 , 1} & {w}_{1 , 2} & ⋯ & {w}_{1 , K} \\ ⋮ & ⋮ & ⋰ & ⋮ \\ {w}_{N - 1 , 1} & {w}_{N - 1 , 2} & ⋯ & {w}_{N - 1 , K}\end{matrix} )}_{ \underline{w} } \cdot \underbrace{( \begin{matrix}{C}_{s , 0} \\ {C}_{s , 1} \\ ⋮ \\ {C}_{s , K - 1}\end{matrix} )}_{\underline{c} is , : \vec{γ}} \\ ∀ s ∈ N , 0 \leq s < {S}_{CF}^{N , K}\end{matrix}$$

The vector on the left-hand side of Equation 10 designates the values of the target impulse response function, in this case the corresponding comb filter function, at interpolation points S N+i, wherein S numbers the segments and i the interpolation points in the segment. The setup impulse response matrix w does not depend on the respective segment since the impulse response functions of the integrate-and-dump filters are orthogonal to one another. The respective weight w can be determined from the general equation for the impulse response functions of the integrate-and-dump filters (Equation 2):

$${w}_{n , K} = ( \frac{n + K - 1}{K - 1} ) . \qquad ( Eq . 8 )$$

For each segment, this results in a system of equations according to Equation 7. If, for example, a sampling rate conversion factor N=8 is assumed and the target impulse response function of a third-order comb filter is used, the following values are obtained for the interpolation points:
h=[1, 3, 6, 10, 15, 21, 28, 36, 42, 46, 48, 48, 46, 42, 36, 28, 21, 15, 10, 6, 3, 1, 0, 0]. (Eq. 9)

where the first eight values correspond to the segment for S=0 from which the three weighting coefficients C₀₀, C₀₁, C₀₂ in the example selected here can be determined. From the second eight interpolation points, C₁₀, C₁₁, C₁₂ is determined and from the last eight values of the vector h, the weighting coefficients C₂₀, C₂₁, C₂₂ are determined. The particular choice of the integrate-and-dump filter here enables the respective weighting coefficients to be determined precisely, which, combined in a matrix, have the following values:

$$\underline{C} = ( \begin{matrix}{C}_{0 , 0} & {C}_{0 , 1} & {C}_{0 , 2} \\ {C}_{1 , 0} & {C}_{1 , 1} & {C}_{1 , 2} \\ {C}_{2 , 0} & {C}_{2 , 1} & {C}_{2 , 2}\end{matrix} ) = ( \begin{matrix}0 & 0 & 1 \\ 36 & 8 & - 2 \\ 28 & - 8 & 1\end{matrix} ) . \qquad ( Eq . 10 )$$

In the text which follows, an arbitrary target impulse response function H_{IAF}(Z) is assumed for explaining the method for determining the weighting coefficients. For a given maximum filter order K, the sampling rate conversion factor N and the length of the target impulse response function, that is to say the number of interpolation points to be taken into consideration, the weighting coefficients Cᵢⱼ can be determined in such a manner that an impulse response function implemented by means of the filter according to the invention essentially corresponds to the target impulse response function H_{IAF}(Z). For this purpose, the weighting coefficients are determined segment by segment.

Starting with H_{IAF}(Z), a system of equations as in Equation 7 is obtained:

$$\begin{matrix}\underbrace{( \begin{matrix}{h}_{s , N + 0} \\ {h}_{s , N + 1} \\ ⋮ \\ {h}_{s , N + N - 1}\end{matrix} )}_{ \underline{h} } = \underbrace{( \begin{matrix}{w}_{0 , 1} & {w}_{0 , 2} & ⋯ & {w}_{0 , K} \\ {w}_{1 , 1} & {w}_{1 , 2} & ⋯ & {w}_{1 , K} \\ ⋮ & ⋮ & ⋰ & ⋮ \\ {w}_{N - 1 , 1} & {w}_{N - 1 , 2} & ⋯ & {w}_{N - 1 , K}\end{matrix} )}_{ \underline{w} } \cdot \underbrace{( \begin{matrix}{C}_{s , 0} \\ {C}_{s , 1} \\ ⋮ \\ {C}_{s , K - 1}\end{matrix} )}_{ \underline{c} } \\ ∀ s ∈ N , 0 \leq s < {S}_{CF}^{N , K} , {w}_{n , K} = ( \frac{n + K - 1}{K - 1} ) ,\end{matrix} \qquad ( Eq . 11 )$$

where h is the interpolation point vector, c is the weighting coefficient vector and w is the impulse response matrix. For the integrate-and-dump filters considered here, the equation is

$${w}_{n , k} = ( \begin{matrix}n + K - 1 \\ K - 1\end{matrix} ) . \qquad ( Eq . 12 )$$

An error vector e is now introduced which has the same dimension as the interpolation point vector h and specifies the magnitude of a respective deviation of the filter created by w C. Thus:
h=W·c+ee=W·c+h. (Eq. 13)

By minimizing the error vector e, for example by means of a method of least error squares, the target impulse response function H_{IAF}(Z) is approximated by the filter according to the invention in the best possible way. A possible residual error or a deviation of the filter impulse response function implemented from the target impulse response function can be specified by ∥e∥=\sqrt{e⁷e}.

As a rule, the higher the number of integration stages in the filter units or the integrator device, respectively, the better the approximation becomes. Predetermining a tolerance threshold for the maximum deviation or specifying a measure for the minimum quality of approximation to the target impulse response function H_{IAF}(Z) makes it possible to determine the filter order necessary in each case.

In the text which follows, a second-order IIR Butterworth filter impulse response with a cut-off frequency ωₙ=0.25 normalized to 3 dB is selected as an example of an arbitrary target impulse response function. The corresponding impulse response function for such a Butterworth filter is:

$$\begin{matrix}{H}_{but2iir} ( z ) = \frac{{b}_{0} + {b}_{1} {z}^{- 1} + {b}_{2} {z}^{- 2}}{1 + {a}_{1} {z}^{- 1} + {a}_{2} {z}^{- 2}} \\ = \frac{0.09763 + 0.1952 {z}^{- 1} + 0.0976 {z}^{- 2}}{1 - 0.94281 {z}^{- 1} + 0.33 {z}^{- 2}} .\end{matrix} \qquad ( Eq . 14 )$$

This Butterworth filter function cannot be completely approximated by a filter according to the invention since it is not possible to implement infinite impulse response functions. For this reason, the target impulse response is cut off after 16 taps in the example chosen here. With a decimation factor of, for example, N=4, S=4 segments are thus obtained in which the target impulse response function H_{but2iir}=H_{but2fir}(Z) is in each case approximated by the impulse response functions of the filter units of the respective order.

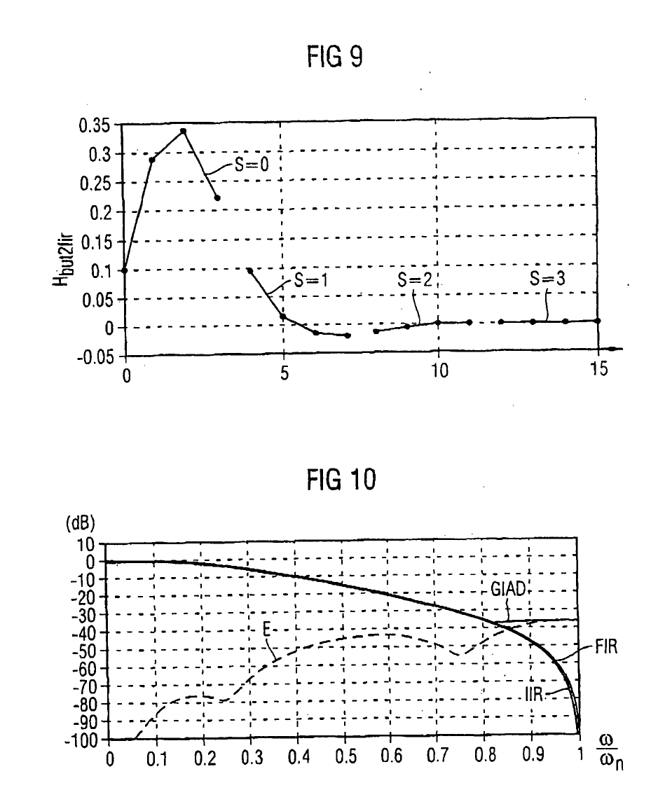

FIG. 9 shows such a target impulse response function with 16 taps according to Equation 17, designated as H_{but2fir}. The segments are herewith designated as s=0, 1, 2, 3. Furthermore, K=3 is assumed as the maximum recursive filter order. From this, the following interpolation point vectors and the setup impulse response matrix are obtained for the target segments from Equation 11:

$$\begin{matrix}\begin{matrix}\underline{w} = ( \begin{matrix}1 & 1 & 1 \\ 1 & 2 & 3 \\ 1 & 3 & 6 \\ 1 & 4 & 10\end{matrix} ) & & {\underline{h}}_{0} = ( \begin{matrix}0.0976 \\ 0.2873 \\ 0.3360 \\ 0.2210\end{matrix} ) & & {\underline{h}}_{1} = ( \begin{matrix}0.0964 \\ 0.0172 \\ - 0.0159 \\ - 0.0207\end{matrix} )\end{matrix} \\ \begin{matrix}{\underline{h}}_{2} = ( \begin{matrix}- 0.0142 \\ - 0.0065 \\ - 0.0014 \\ 0.0009\end{matrix} ) & & {\underline{h}}_{3} = ( \begin{matrix}0.0013 \\ 0.0009 \\ 0.0004 \\ 0.0001\end{matrix} ) .\end{matrix}\end{matrix} \qquad ( Eq . 15 )$$

From this, the following is obtained for the weighting coefficients:

$$\begin{matrix}{\underline{c}}_{0} = ( \begin{matrix}- 0.250033 \\ 0.498865 \\ - 0.152331\end{matrix} ) & & {\underline{c}}_{1} = ( \begin{matrix}0.208256 \\ - 0.149967 \\ 0.037177\end{matrix} ) \\ {\underline{c}}_{2} = ( \begin{matrix}- 0.024772 \\ 0.013253 \\ - 0.002737\end{matrix} ) & & {\underline{c}}_{3} = ( \begin{matrix}0.001711 \\ - 0.000439 \\ 0.000014\end{matrix} )\end{matrix} \qquad ( Eq . 16 )$$

The maximum deviation from the target impulse response function or the quality of the approximation, respectively, can be written in a compact way by also arranging the vectors of the weighting coefficients cᵢ and the interpolation point vectors in a matrix:
c=(c₉ c₁ . . . c_{S-1}) (Eq. 17)
H=(h₉ h₁ . . . h_{S-1})

so that an N×S error matrix E can be represented as
H=W·C+E. (Eq. 18)

A measure of the maximum deviation between the target impulse response function and the impulse response function implemented by the filter can thus be expressed as:

$${E}_{max} = {\sum }_{s = 0}^{S - 1} {\sum }_{n = 0}^{N - 1} \vert \underline{E} ( n , s ) \vert . \qquad ( Eq . 19 )$$

In the example of the Butterworth target impulse function shown here, it has been assumed, for example, that Eₘₐₓ=−35.718 dB. With K=3 and N=4, a virtually conjugate impulse response function is obtained as is shown in FIG. 9.

FIG. 10 shows the corresponding error E in dependence on the frequency W normalized to the cut-off frequency WₙGN=0.25. The curve IIR specifies the frequency response of the filter according to Equation 14, FIR specifies an IIR filter cut off after 16 taps and curve GIAD specifies the frequency response of the filter constructed in accordance with the invention. Curve E shows the maximum deviation from the target impulse response function, which in this case is always below about −35 dB.

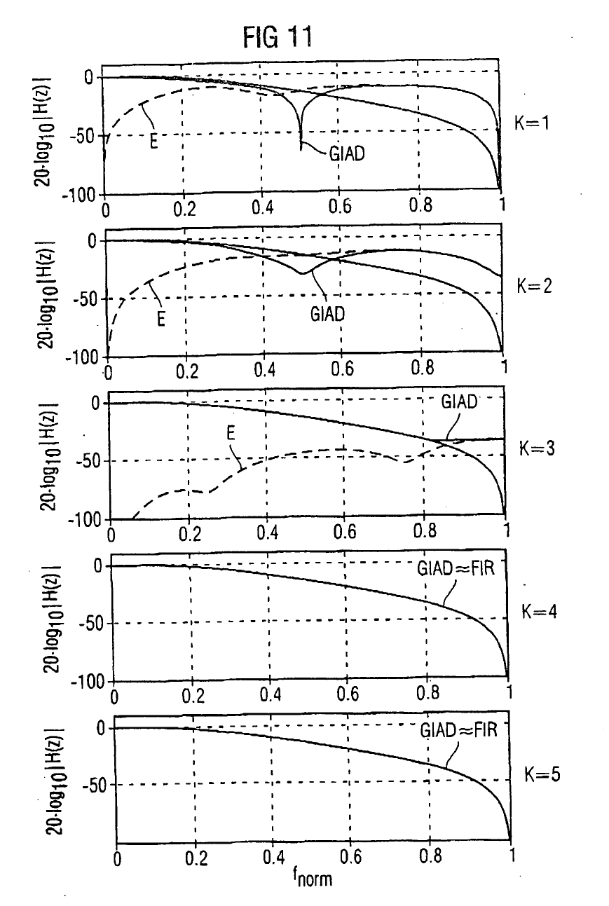

Essentially, the maximum order K represents a limit to the possible accuracy or quality of the approximation by the filter according to the invention. FIG. 11 shows similar error curves for corresponding filters according to the invention with K=1st, 2nd, 3rd, 4th and 5th order. From an order of K=4 onward, the error is below −100 dB so that the curve for the filter according to the invention corresponds to the target impulse response function in practice. Investigations by the applicant have shown that an order of K≦8 is usually sufficient for achieving adequate accuracies.

If the maximum recursive order of the filter according to the invention is increased, some of the weighting coefficients can become particularly small. As a rule, an increase in the order creates in the system of equations for determining the weighting coefficients (Eq. 11) more degrees of freedom than are unambiguously determined by the system of equations.

A numeric comparison of the order of magnitude of the weighting coefficients for K=4 and K=5 of the preceding example of the Butterworth filter approximation shows that with a maximum recursive order of K=5, the weighting coefficients C_{s,1} are practically zero, or are so small that they can be set to zero without deterioration in the quality of approximation of the filter.

An over approximation by means of increasing the maximum recursive order of the filter thus results, on the one hand, in a better approximation to the target impulse response function but, on the other hand, not necessarily in a greater number of non-disappearing weighting coefficients. These findings enable an improved method for determining the weighting coefficients of a digital filter according to the invention to be specified.

For this purpose, a fourth-order comb filter function with zero points shifted with respect to a fourth-order standard comb filter is considered as target impulse response function:

$${H}^{smeared} ( z ) = \frac{1}{{N}_{1} \cdot {N}_{2} \cdot {N}^{2}} \cdot {( \frac{1 - {z}^{- N}}{1 - {z}^{- 1}} )}^{2} \cdot \frac{1 - {z}^{- {N}_{1}}}{1 - {z}^{- 1}} \cdot \frac{1 - {z}^{- {N}_{2}}}{1 - {z}^{- 1}} . \qquad ( Eq . 20 )$$

As a decimation factor, N=16 is here selected where N₁=N−2 and N₂=N+2 is selected whereas N₁=N₂=N for the standard comb filter. To accurately approximate the target filter function, particularly in the first two aliasing bands at frequencies fₙₒᵣₘ=0.125 and fₙₒᵣₘ=0.25, a highest order with K=6 is selected for a decimation or interpolation filter according to the invention. The predetermined tolerance threshold for a deviation of the impulse response function implemented by the filter according to the invention from the target impulse response function according to Equation 19 is selected to be 90 dB.

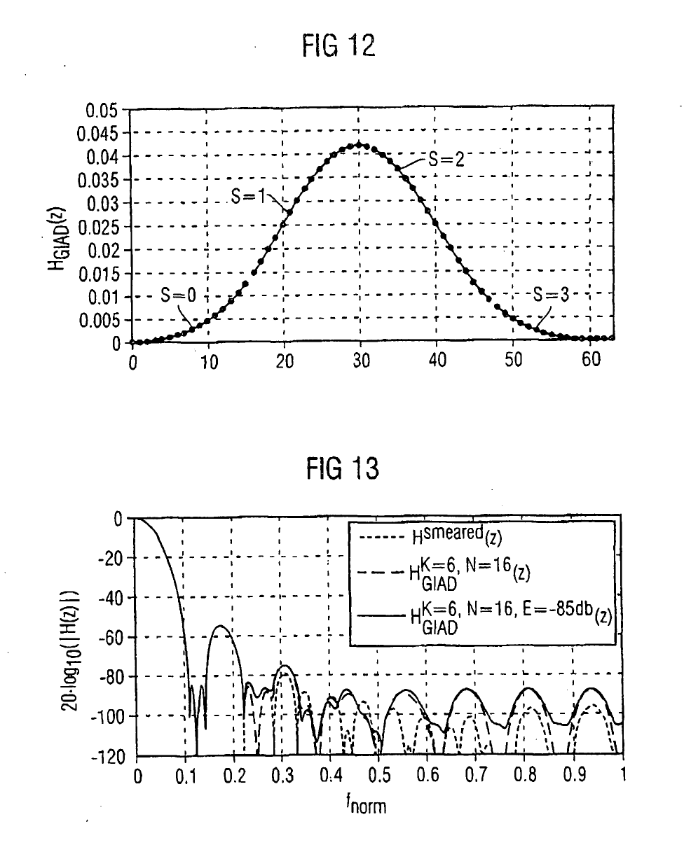

FIG. 12 shows an impulse response function with four segments, implemented in accordance with the invention, which is implemented by means of a filter according to the invention of integrate-and-dump filters with K=6, N=16 and S=3. To operate the filter, M=(k+1)×(S=1)=6×4=24 multiplications by weighting coefficients in the baseband clock rate are required.

The implementation and computing effort for such a filter can be reduced by looking for sets of weighting coefficients in which as many weighting coefficients C_{i,j} as possible are zero or have such small values that they can be set to zero without significantly increasing the deviation of the filter impulse response functions H_{GIAD}(Z) achieved from the target impulse response function. Each weighting coefficient which can be set to zero, therefore, reduces the computing effort or implementation effort since the respective adders and multipliers can be omitted.

When designing a filter according to the invention, therefore, weighting coefficients in a defining equation as specified, for example, in Equation 11, are firstly systematically set to zero and the optimization or interpolation is performed. In this improved design method for determining the filter coefficients or the weighting coefficients, all combinations of coefficients C_{i,j} set to zero are determined and the respective maximum deviation of the filter impulse response function achieved in this manner from the target impulse response function is calculated. Following this, the set of weighting coefficients which shows most of the disappearing weighting coefficients with a predetermined tolerance threshold for this deviation or quality of approximation of the filter according to the invention is selected.

Using Equation 11 as the basis, a masking matrix M is inserted for implementing the respective boundary condition that certain coefficients should be zero:

$$\underline{h} = \underline{M} \cdot \underline{W} \cdot \underline{c} + \underline{e} = {\underline{W}}^{M} \cdot \underline{c} + \underline{e} \\ \underbrace{( \begin{matrix}{h}_{s \cdot N + 0} \\ {h}_{s \cdot N + 1} \\ ⋮ \\ {h}_{s \cdot N + N - 1}\end{matrix} )}_{ \underline{h} } = \underbrace{\underbrace{( \begin{matrix}{m}_{0} & 0 & 0 & 0 \\ 0 & {m}_{1} & 0 & 0 \\ 0 & 0 & ⋰ & 0 \\ 0 & 0 & 0 & {m}_{K - 1}\end{matrix} )}_{ \underline{M} } \cdot \underbrace{( \begin{matrix}{w}_{0 , 1} & {w}_{0 , 2} & ⋯ & {w}_{0 , K} \\ {w}_{1 , 1} & {w}_{1 , 2} & ⋯ & {w}_{1 , K} \\ ⋮ & ⋮ & ⋰ & ⋮ \\ {w}_{N - 1 , 1} & {w}_{N - 1 , 2} & ⋯ & {w}_{N - 1 , K}\end{matrix} )}_{ \underline{W} }}_{ {\underline{W}}^{M} } \cdot \underbrace{( \begin{matrix}{C}_{s , 0} \\ {C}_{s , 1} \\ ⋮ \\ {C}_{s , K - 1}\end{matrix} )}_{ \underline{c} } + \underbrace{( \begin{matrix}{e}_{e \cdot N + 0} \\ {e}_{e \cdot N + 1} \\ ⋮ \\ {e}_{e \cdot N - N - 1}\end{matrix} )}_{ \underline{e} } \qquad ( Eq . 21 )$$

where the matrix elements mₖ of the masking matrix W are in each case set to zero or to 1:=0.1 with k=0 to K−1. For Equation 21, an optimization with regard to the least error squares is then performed for each possible combination of mₖ=0.1. The set of weighting coefficients, which is optimal due to this search, for a respective segment s can be represented as follows:

$${\underline{c}}_{s}^{opt} \text{:} {\underbrace{( \underline{h} - {\underline{M}}_{s}^{opt} \cdot \underline{W} \cdot {\underline{c}}_{s}^{opt} ) {( \underline{h} - {\underline{M}}_{s}^{opt} \cdot \underline{W} \cdot {\underline{c}}_{B}^{opt} )}^{T}}}_{= {\sum }_{n = 0}^{N} {\vert {\underline{e}}_{s} ( n ) \vert}^{2}} < \frac{{E}_{max}}{S} {\vert}_{min ( rg ( {\underline{M}}_{s}^{opt} ) )} \qquad ( Eq . 22 )$$

Following the example of a comb filter target impulse response function shown in FIG. 12 and with K=6 for the maximum recursive order of the digital filter according to the invention for implementing this target impulse response function, a saving of 17% of multiplications needed can be achieved by searching for the sets of coefficients having the most coefficients set to zero, with a predetermined tolerance threshold Eₘₐₓ=−88 dB. An optimization by searching for the sets of weighting coefficients having the most weighting coefficients set to zero is obtained in that C₀₀, C₀₁, C₂₄, C₃₄, C₃₅ can be set to zero without deterioration in the required quality of approximation.

FIG. 13 shows the respective frequency responses achieved, with K=6 6, 16 H_{GIAD}(Z) of the target impulse response function H_{smeared}(z). The curves are virtually superimposed, particularly in the area up to fₙₒᵣₘ=0.25. The dotted line represents the target impulse response function H_{smeared}(z), the dashed line represents the impulse response function achieved by a filter according to the invention with non-disappearing weighting coefficients, and the continuous line represents a filter implemented in accordance with the improved design method according to the invention, in which the aforementioned five weighting coefficients are set to zero. The maximum deviation between the target impulse response function and the target impulse response function achieved is here selected to be Eₘₐₓ=−85 dB.

The improved design method thus initially generates an underdetermined system of equations for determining the weighting coefficients in the respective segment and then in each case uses trial sets of weighting coefficients in which one or more weighting coefficients are set to zero. To achieve the filter according to the invention, the trial sets of weighting coefficients are then selected in which the most weighting coefficients are set to zero and, at the same time, the maximum deviation Eₘₐₓ is below the predetermined tolerance threshold.

A further reduction in the necessary multiplications or the adders and multipliers to be implemented in the weighting network can be achieved when using symmetric target impulse response functions.

Since, according to the invention, the target impulse response function is implemented segment by segment, the segments must be symmetrically distributed to the interpolation points of the target impulse response functions for utilizing the symmetry. This will be explained in greater detail with the example of the comb filter function with shifted zero points:

$$\begin{matrix}{H}^{smeared} ( z ) = \underbrace{{\sum }_{i = 0}^{L - 1} {h}_{i} {z}^{- i}}_{FIR Modes} \\ = \underbrace{{\sum }_{i = 0}^{L / 2 - 1} \overbrace{{h}_{i} ( {z}^{- i} + {z}^{L - i - 1} )}^{Jointly used multiplications}}_{symmetric modes} .\end{matrix} \qquad ( Eq . 23 )$$

To utilize the symmetry of these target impulse response functions in the context of the filter arrangements according to the invention, the segments must be placed symmetrically in such a manner that pairs of segments with mutually symmetric target impulse response functions are in each case present.

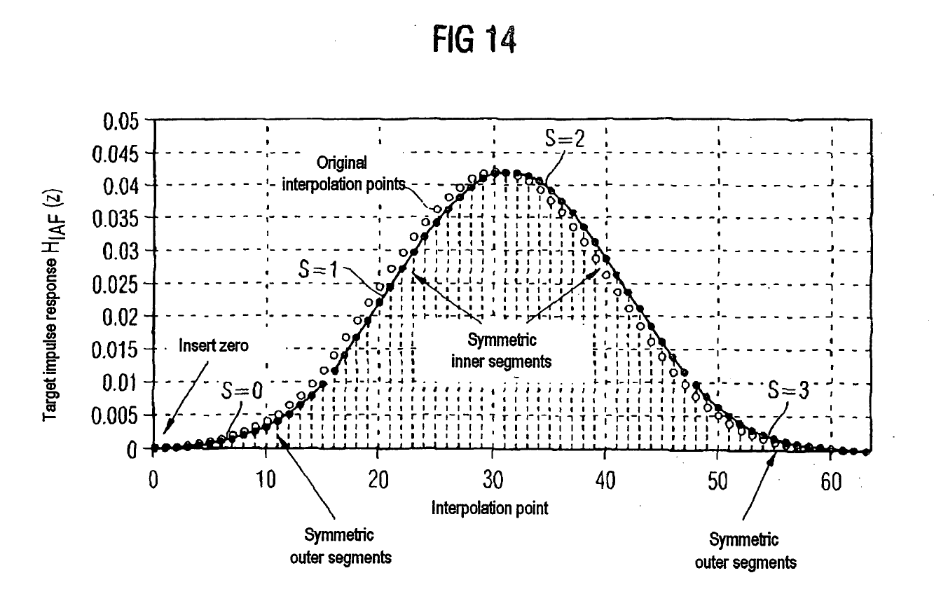

FIG. 14 illustrates how a symmetric impulse response function for processing with a symmetric filter according to the invention can be processed. To achieve two symmetric inner segments, a zero interpolation point was inserted at 0 so that the target impulse response function has an even length or even number of interpolation points. With the sampling rate conversion factor N=16 selected here, this results in 64 interpolation points. The segments s=0 and s=3 and segments s=1 and s=2 are thus symmetric with respect to one another. This means that, in principle, in a conversion according to the invention, the same values are calculated by the digital filter or, respectively, that pairs of equal weighting coefficients can be found. The multiplication by these identical weighting coefficients can thus be used at the same time for a number of segments which saves computing and implementation effort.

The number of segments needed for a target impulse response function with even symmetry prepared in this manner is, therefore:

$${S}^{half} = ⌈ \frac{L}{2 N} ⌉ \\ {L}^{half} = N \cdot {S}^{half} = 16 \cdot 2 = 32 \\ {L}^{ins} = {L}^{app} = {L}^{half} - \frac{L}{2} = 32 - \frac{62}{2} = 1 , \qquad ( Eq . 24 )$$

where rounding to the next higher integral number was performed. A corresponding desired symmetric matrix of weighting coefficients C^{SYM} can be written as:

$$\begin{matrix}{\underline{C}}^{sym} = ( \begin{matrix}\begin{matrix}{\underline{c}}_{0} & {\underline{c}}_{1} & ⋯ & {\underline{c}}_{{S}^{half} - 1}\end{matrix} & \begin{matrix}{\underline{c}}_{{S}^{half} - 1} & ⋯ & {\underline{c}}_{1} & {\underline{c}}_{0}\end{matrix}\end{matrix} ) \\ = ( \begin{matrix}{\underline{C}}_{left}^{sym} & {\underline{C}}_{right}^{sym}\end{matrix} ) \\ = ( \begin{matrix}\underbrace{\begin{matrix}{c}_{0 , 0} & {c}_{0 , 1} & ⋯ & {c}_{0 , {S}^{half} - 1} \\ {c}_{1 , 0} & {c}_{1 , 1} & ⋯ & {c}_{1 , {S}^{half} - 1} \\ ⋮ & ⋮ & ⋰ & ⋮ \\ {c}_{K - 1 , 0} & {c}_{K - 1 , 1} & ⋯ & {c}_{K - 1 , {S}^{half} - 1}\end{matrix}}_{ {\underline{C}}_{left}^{sym} } & \underbrace{\begin{matrix}{c}_{0 , 0} & ⋯ & {c}_{0 , 1} & {c}_{0 , 0} \\ {c}_{1 , {S}^{half} - 1} & ⋯ & {c}_{1 , 1} & {c}_{1 , 0} \\ ⋮ & ⋰ & ⋮ & ⋮ \\ {c}_{K - 1 , {S}^{half} - 1} & ⋯ & {c}_{K - 1 , 1} & {c}_{K - 1 , 0}\end{matrix}}_{ {\underline{C}}_{right}^{sym} }\end{matrix} ) .\end{matrix} \qquad ( Eq . 25 )$$

The resultant impulse response function implemented by the filter according to the invention is thus:
H^{GIAD}=W·C^{sym}=H−E, (Eq. 26)

wherein a symmetric impulse response matrix is desirable:
H^{SYM GIAD}=(hₛ h₁ . . . Hₛ|hₛ^{flip}₁ . . . H₁^{flip}h_{G}^{flip})=(H_{lift}^{SUM-GIAD}|H_{right}^{SYM-GIAD}) (Eq. 27)
hₛ^{flip}=(h_{0,s}^{flip}h_{1,s}^{flip} . . . hₛ^{flip})^{T}=(h_{s 1,s} . . . h_{1,s}h_{0,s})^{T}=flipud(hₛ^{flip})^{s}

where flipup designates a mapping flipup (a, b, c)=(c, b, a).

The matrix w describing the structure of the filter according to the invention must be modified, therefore. The first two segments, designated by s=0 and s=1 in FIG. 14, can be generally described as in the previous equations. To describe symmetric general filters by means of an architecture according to the invention, the following is obtained, for example, for an interpolation filter:
H_{left}^{SYM-GIAD}=W_{left}^{sym}·C_{left}^{sym} (Eq. 28)
H_{right}^{SYM-GIAD}=W_{right}^{sym}·C_{right}^{sym}

The symmetric extension with the index “right” must then have the following form:
H_{right}^{SYM-GIAD}=flipud(H_{left}^{SYM-GIAD}) (Eq. 29)
C_{right}^{sym}=fliplr(C_{left}^{sym})
W_{right}^{sym}=flipud(W_{left}^{sym}).

In the implementation, Equations 27 to 29 amount to a time reversal for the right segments.

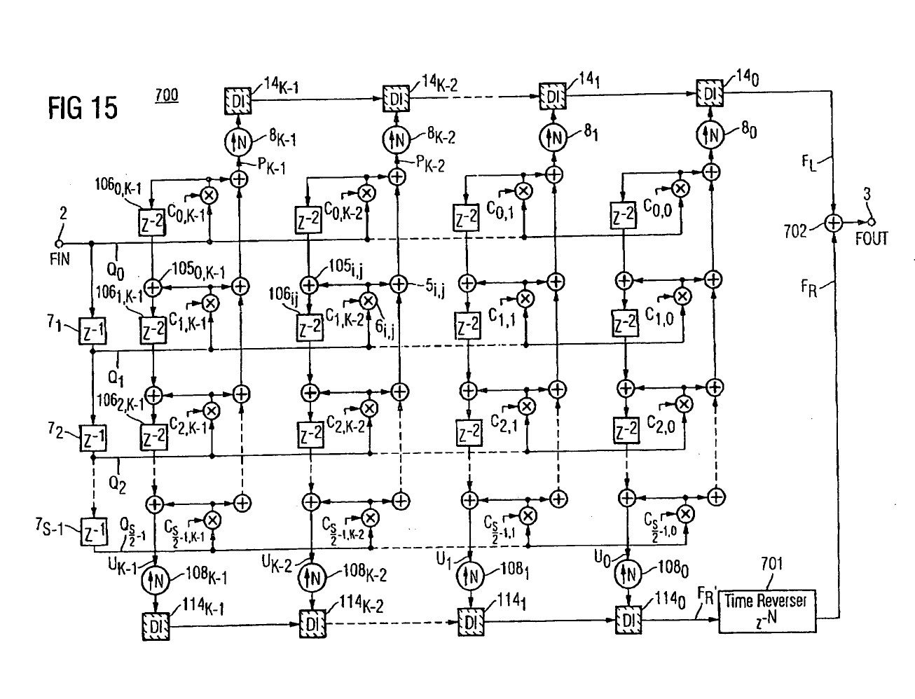

FIG. 15 shows an interpolation filter 700 according to the invention for implementing a symmetric target impulse response function. Essentially, a weighting network as already shown in FIG. 4 is used but the multipliers 6_{i,j} in each case allocated to the weighting coefficients Cᵢⱼ also generate signals for the symmetric right-hand component of the target impulse response function which are in each case supplied to other adders 105_{i,j}. Therefore, further precharge signals Uⱼ, with j=0 to K−1, are generated which are supplied to other gating devices 108ⱼ. For designating the adders, multipliers and gaters, the same notation has been used as in FIGS. 1 to 4 even if not all elements are explicitly provided with reference symbols.

For implementing the respective symmetric right-hand segments of the target impulse response function, the internal delayed signals Qᵢ with i=0 to S/2−1, are multiplied by the weighting coefficients and delayed by a delay time which is allocated to the respective weighting coefficients. The internal signals thus weighted and delayed are then combined to form a linear combination and supplied to a respective gating device 108ⱼ.

In the illustrative embodiment of the interpolation filter 700 shown in FIG. 14, further delay elements 106ᵢ are provided, with i=0 to S/2−2. Each column of the matrix of weighting coefficients is thus allocated to a chain of further series-interconnected delay elements 106ᵢⱼ, wherein an adder 105ᵢⱼ which is supplied with the respective delayed internal signal weighted with a weighting factor is in each case provided between the delay elements 106ᵢⱼ.

The delay elements 106ᵢⱼ in each case have a delay of z⁻² in the baseband rate. The further symmetric precharge signals Uⱼ, with j=0 to K−1, thus generated in each case are conducted to the filter units or integrate-and-dump filters 114ⱼ, with j=0 to K−1, by the further gating devices 108ⱼ.

In this arrangement, the integrate-and-dump filters here designated by 14ⱼ or 114ⱼ, respectively, correspond, for example, to the series-interconnected delay elements shown in FIG. 5. The first chain of delay elements 14ⱼ delivers a first symmetric filter signal F_{L} and the second chain of delay elements 114ⱼ delivers a second symmetric filter signal F_{R′}.

The output of the second chain of delay elements 114ⱼ interconnected as integrate-and-dump filters is followed by a time reverser 701 which outputs a second time-reversed filter signal F_{R}. The signals F_{L} and F_{R} are combined by means of an adder 702 to form the filter output signal FOUT.

By means of the arrangement of additional delay elements 106ᵢⱼ with the respective delay factors z⁻² in the baseband, the further gater 108ⱼ and filter device 114 and the time reverser 107, the symmetric right-hand segments are correctly converted in the filter.

The interpolation filter 700 according to FIG. 14, therefore, delivers the desired symmetric target impulse response function with high accuracy with an implementation effort reduced by one half. Compared with the asymmetric embodiment, for example as shown in FIGS. 1 to 5, only half the number of multiplications by various weighting coefficients are performed.

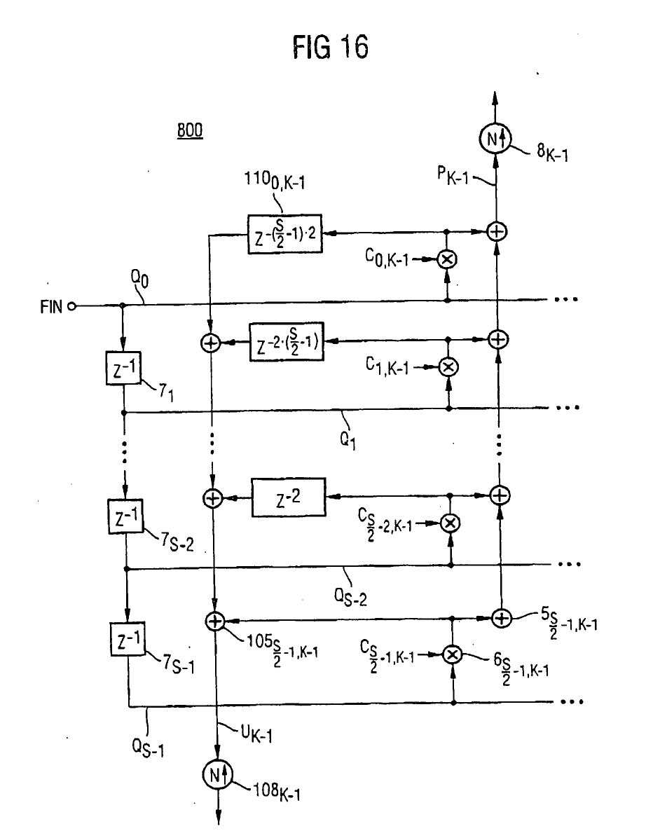

As an alternative to the chain of further delay elements 106_{i,j}, the weighted internal signals delivered by the multipliers 6_{i,j} can also be first delayed by means of variously arranged delay elements and then combined via an adder chain. A corresponding illustrative embodiment is shown in FIG. 16.. The respective delayed internal signals Qᵢ are first multiplied by the weighting coefficients via the multiplier 6 and are then delayed in the associated delay devices 110_{i,j}. In this arrangement, a delay of z⁻²(S/2−1−i) is in each case allocated to a weighting coefficient C_{i,j}.

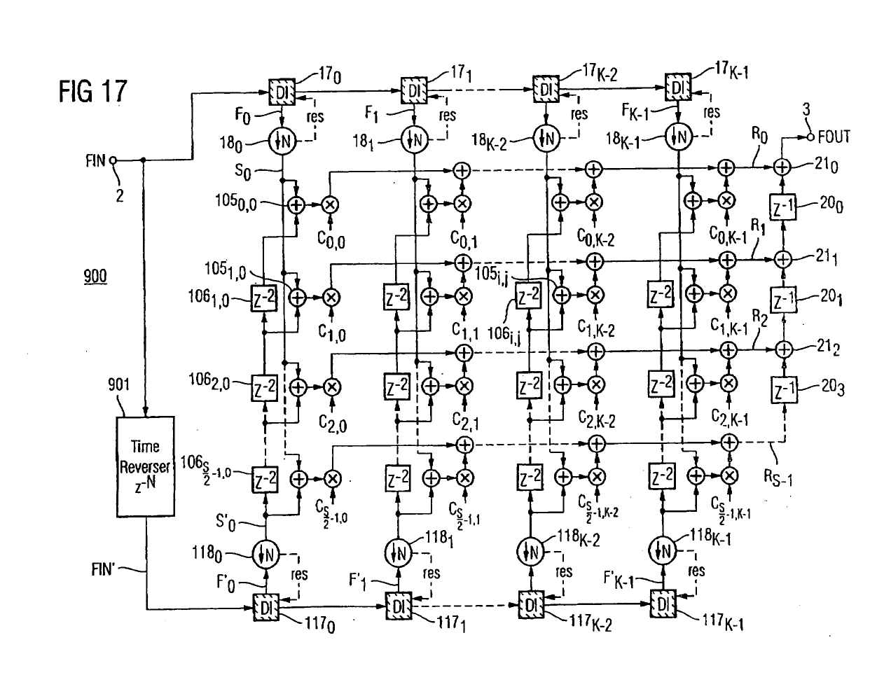

FIG. 17 shows a corresponding decimation filter 900 for implementing a symmetric target impulse response function. As already shown in FIG. 15, further sampling devices 118ⱼ, with j=0 to K−1, are provided, and other integrate-and-dump filter units 117ⱼ or series-interconnected delay elements with feedback, respectively. The input 2 of the symmetric decimation filter 900 is coupled to a time reverser 901 which delivers a time-reversed input signal FIN′ to the chain of further integrate-and-dump filters 117ⱼ. The sampling devices 118ⱼ are in each case supplied with filter signals F_{j′}.

A chain of series-interconnected delay elements 106_{i,j} is coupled to a respective further sampling device 118ⱼ. The delay elements 106_{i,j} in each case have a delay of z⁻² and deliver delayed sampling signals to the adders 105_{i,j}. The respective segment signals Rⱼ are thus obtained as a linear combination of the sums of the first sampling signals S0, which correspond to the left-hand segments, and the respective delayed further (right-hand) sampling signals S0′ of the further sampling device 118ⱼ.

The properties of the digital filter for sampling rate conversion according to the invention are particularly suitable for use in polyphase filters. Due to the structure of the respective digital filter with weighting network, integrate-and-dump filter chain and possibly symmetric configuration, they are particularly suitable for use in polyphase filters.

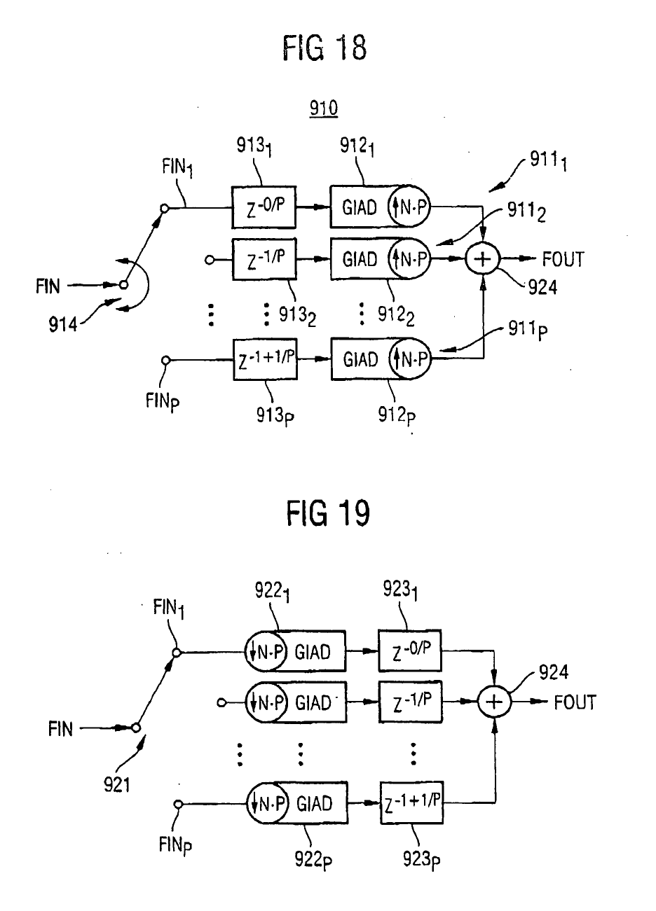

FIGS. 18 and 19 show polyphase arrangements for an interpolation filter 910 and a decimation filter 920 by means of the digital filter according to the invention.

The interpolation filter has a number P of filter branches 911ᵣ, with r=1 to P, which in each case have an interpolation filter 912ᵣ according to the invention preceded by a delay device 913ᵣ. In this arrangement, the delay device 913₁ of the first filter branch 911₁ does not have any delay, the second delay device 913₂ has a delay of z^{-1/P}, where an rth filter branch in each case has a delay device with a delay of z^{-1+1r}. An adder 924 combines the filtered branch signals. At the input end, a switching device 914 is provided which distributes the input signal FIN to the filter branches 911ᵣ. The low-rate data stream of the input signal FIN is thus operated at a P-times lower clock frequency by the digital filter arrangement 912ᵣ of a respective filter branch.

FIG. 19 shows an analogous embodiment as polyphase decimation filter. The decimation filter 920 has a switching device 921 which splits a high-rate input signal FIN clock pulse by clock pulse into P branch signals FINᵣ, with r=1 to P, in the P filter branches. The branch signals FINᵣ have a sampling rate which is extended P-fold. The branch signals are supplied to filter arrangements 922ᵣ according to the invention, with r=1 to P, which are constructed here as decimation filters and which are in each case followed by a delay device 923ᵣ which in each case supplies an output branch signal to an adder 924. The adder 924 combines the individual output signals of the branch filters to form the output signal FOUT. Thus, the respective filters according to the invention are in each case operated at a clock rate reduced by the factor P, that is to say the number of polyphases. In addition, the same weighting coefficients are used for implementing a particular target impulse response function for the individual filter branches. To form a polyphase filter arrangement, only fractions of delays with a respective difference from one another of 1/P need to be provided. The greatest delay needed is Dₘₐₓ=(P−1) divided by P.

It is possible, therefore, for example in an embodiment as interpolation polyphase filter, to use the sampling devices jointly and to operate them with a clock frequency which is not reduced. The sampling signals correspondingly present can then be supplied in each case clock pulse by clock pulse to a respective chain of integrate-and-dump filters which form an integrator device in the sense of FIG. 4.

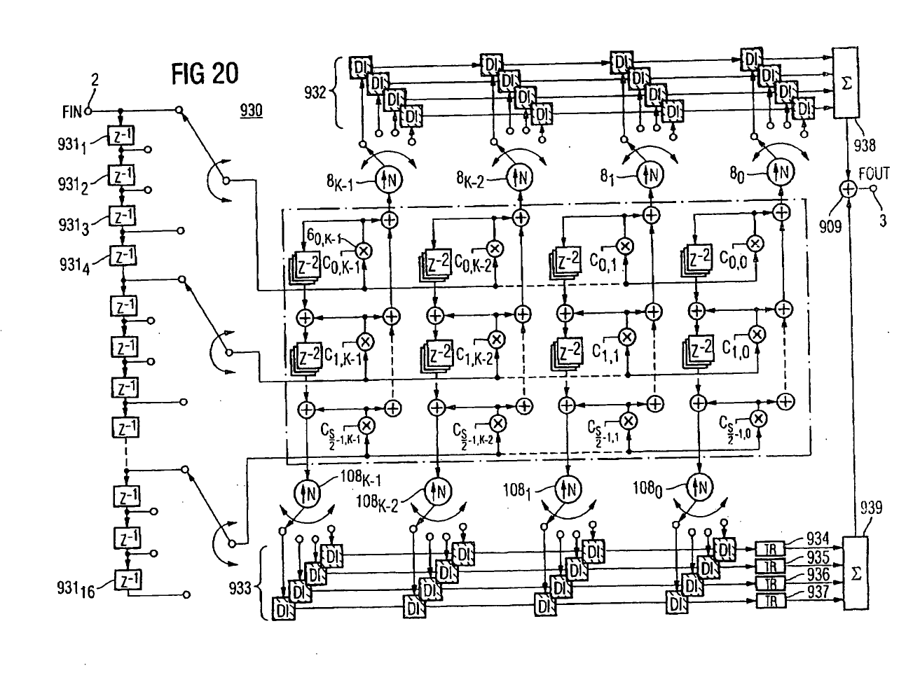

FIG. 20 shows a polyphase filter 930 arranged as interpolation filter. A common weighting network 4 is provided which has here a symmetric structure as is explained in greater detail in the embodiment 700 according to FIG. 15. At the input 2 of the polyphase filter 930, a chain 931 of series-interconnected delay elements is provided. The example shown here has P=4 polyphases. In this arrangement, a delayed internal signal can be supplied to each row of weighting coefficients Cᵢⱼ or, respectively, to the associated multipliers 6ᵢⱼ. In the example shown here, S/2−1 rows are provided. Thus, 4 (S/2−1)−2 delay elements are thus connected in series at the input 2 of the polyphase filter 930. The branch signals can be picked up in each case between the delay elements 931ᵣ.

The multiplications for calculating the linear combination of internal signals, now delayed, are in each case carried out with a delay of 1/P of the baseband sampling period. The weighting network 4 is thus operated at the usual clock rate but outputs via the respective gating devices 8ⱼ or 108ⱼ, respectively, sampling signals to the integrate-and-dump filter chains 932, 933 provided P=5-times. The respective filter units or integrator devices for the filters of the P filter branches must be provided P-times. With the symmetric configuration as shown in FIG. 20, there are accordingly also P=4 time reversers 934, 935, 936, 937 which are provided analogously to the individual time reverser for the right-hand symmetric segments as explained with respect to FIG. 17. The symmetric branch signals thus generated are in each case added in an adding device 938, 939 and output to a third adding device 909 which combines them to form the output signal FOUT.

An advantage of the polyphase embodiment of the filter according to the invention consists in that due to the sampling rate conversion factor of the individual branches, which is effectively reduced by P, the interpolation points for determining the filter coefficients or the weighting coefficients, respectively, can be spaced apart further from one another. The respective impulse response functions implemented by the filter branches thus cover a greater range of target impulse response functions in absolute terms. Compared with the simple embodiment without polyphase, the interpolation points are spaced apart by in each case P interpolation points, the sampling rate conversion factor N being the same. This may achieve a better approximation to the target impulse response function.

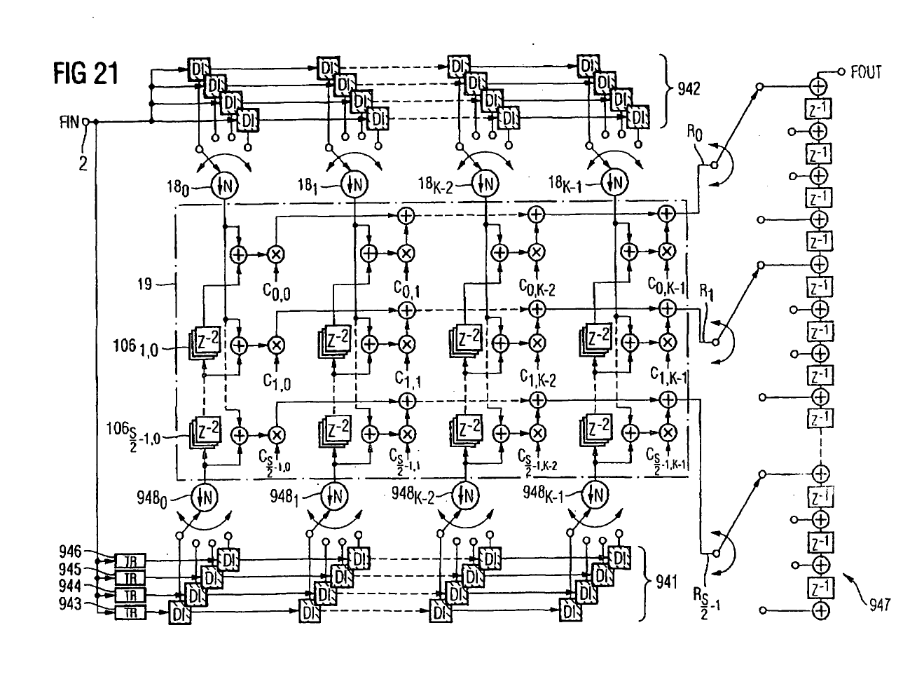

FIG. 21 shows a polyphase filter arrangement according to the invention as decimation filter 940. The input signal FIN is in each case supplied to K=4 chains of integrate-and-dump filters 942 and since a symmetric embodiment is shown, also to the second integrate-and-dump filters 941 which are in each case preceded by a time reverser 943, 944, 945, 946. A common weighting coefficient network 19 is provided which is coupled via the sampling devices 18ⱼ, 948ⱼ, where j=0 to K−1. The delay elements 106_{i,j} interconnected as chain and necessary for the right-symmetric sampling signals must also be provided P-times, that is to say four-times in this case. The segment signals supplied by the weighting network 19 are conducted clock pulse by clock pulse to an adder provided between the delay elements of a delay element chain. At the output 3 of the polyphase filter device 940, a chain of series-interconnected delay elements 947 is accordingly provided, the number of delay elements being P (S/2−1)−1.

A particular advantage of the polyphase embodiment lies in the reduction of the effective interpolation or decimation factor for the individual branches, the segment length or the number of interpolation points covered by the segments of the target impulse response function depending on the decimation or interpolation factor N, respectively. In the polyphase filter embodiment, a range of interpolation points of the target impulse response function is covered which is P-times longer. As a result, fewer segments and segment connections need to be taken into consideration overall. This makes it possible to achieve better approximations. In an optimum case, a chain of integrate-and-dump filters with a predetermined maximum recursive order would follow the complete length of the target impulse response function. In particular, this also simplifies the search for weighting coefficients which can be set to zero.

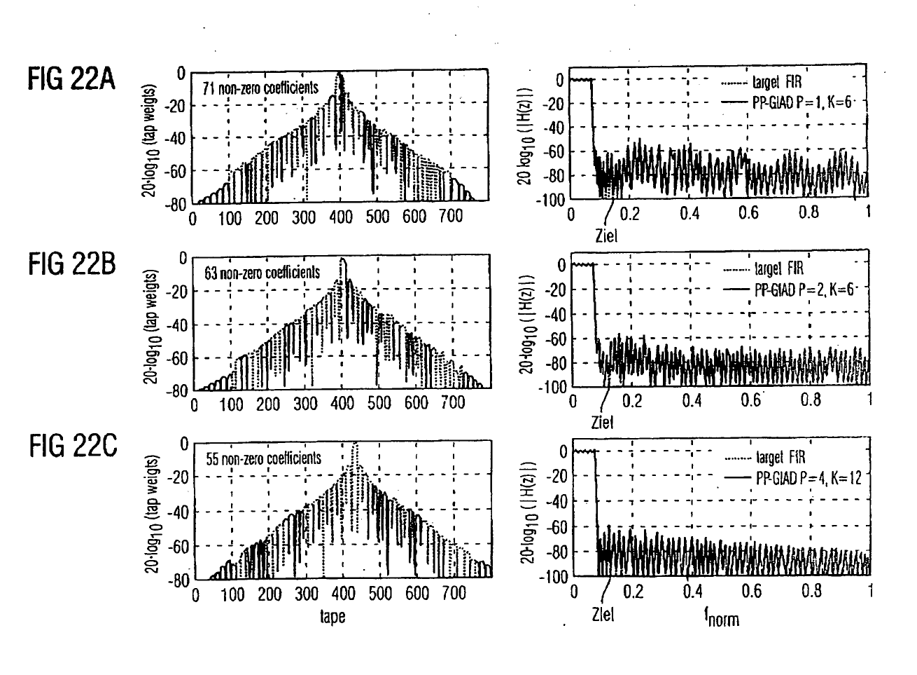

FIG. 22 shows the impulse response and frequency responses of polyphase interpolation filters with an interpolation factor N=12 and a stop attenuation of −50 dB. Row (A) designates a simple interpolation filter according to the invention with a maximum recursive order of K=6. Due to an optimization according to the invention for finding the largest number of weighting coefficients which can be set to zero, 71 weighting coefficients are unequal to zero. The second row (B) shows impulse response and frequency response of a filter according to the invention as a polyphase embodiment with P=2, the maximum order being K=8. In this case, only 63 non-disappearing weighting coefficients are necessary. In row (C), a quadruple polyphase P=4 is used, and a maximum recursive order of K=12. In the latter case, only 55 weighting coefficients are unequal to zero. In addition, the approximation to the target impulse response is improved by increasing the recursive orders K and the number of polyphases. Whereas the attenuation in row (A) of the stop band is about −50 dB, it is already distinctly below −50 dB in the case of a double polyphase and in row (C) with a quadruple polyphase it is already in the required stop band at −60 dB.

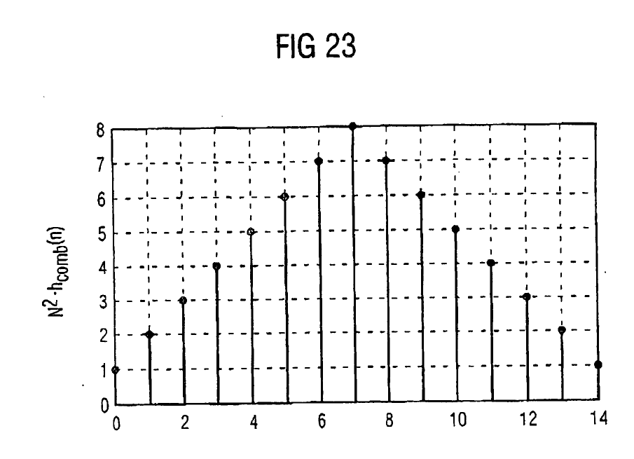

A further possibility for making the filter according to the invention more efficient consists in limiting the dynamic range of the integration chains or the integrator devices, respectively. With each integration stage or each integrate-and-dump filter, respectively, of the integrate-and-dump filter chain, the bit width of the corresponding output signal increases. The greater this bit width, the greater the demands which must also be made on the corresponding weighting coefficients with regard to their quantization or accuracy, respectively. Usually, an output signal FOUT with a bit width of only about 16 bits is needed. For a target impulse response shown in FIG. 23, which corresponds to an impulse response function of a second-order comb filter, the following weighting coefficients are obtained with an interpolation factor of N=8:

$$\underline{C} = ( \begin{matrix}{\underline{c}}_{0} & {\underline{c}}_{1}\end{matrix} ) = ( \begin{matrix}{c}_{0 , 0} & {c}_{0 , 1} \\ {c}_{1 , 0} & {c}_{1 , 1}\end{matrix} ) = ( \begin{matrix}0 & + \frac{1}{8} \\ 1 & - \frac{1}{8}\end{matrix} ) . \qquad ( Eq . 30 )$$

More advantageously scaled weighting coefficients can be achieved by inserting shifting devices between the integrate-and-dump filter units.

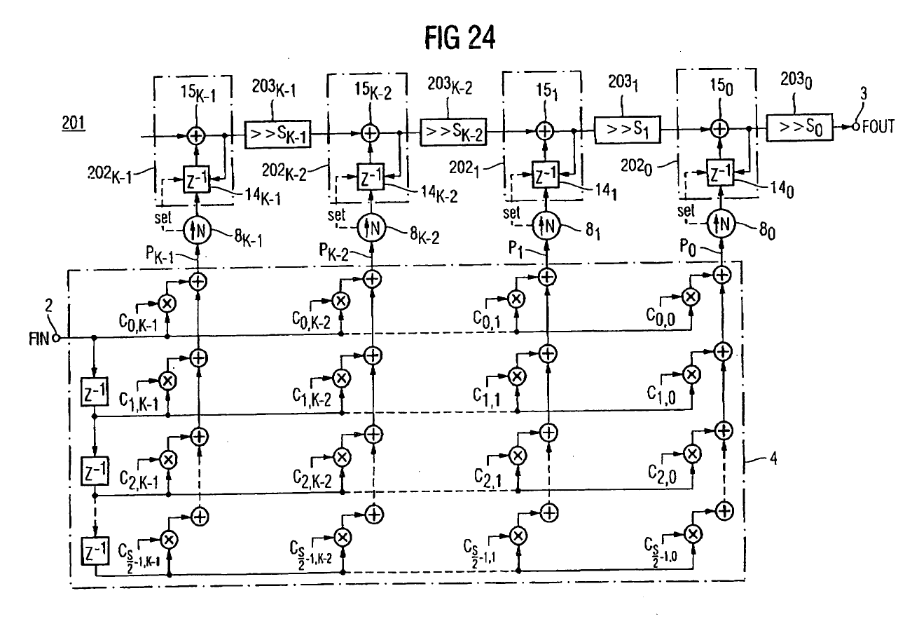

FIG. 24 shows, for example, an interpolation filter 201 in which integrate-and-dump filters with feedback are connected together to form a chain as shown in FIG. 4. Each integrate-and-dump filter unit 202ⱼ, with j=0 to K−1, in each case has one delay element 14ⱼ with feedback and one adder 15ⱼ. Between the integrate-and-dump filters 202ⱼ, shifting devices 203ⱼ are in each case provided. The shifting device 208ⱼ reduces the dynamic range within the chain of integrate-and-dump filters. Furthermore, the weighting coefficients can be scaled better.

With a shift for a second-order interpolation filter according to the invention, with two segments with a shifting factor of S₀=0 and S₁=3, the following improved weighting matrix is obtained for the abovementioned example of the target impulse response function shown in FIG. 23:

$$\underline{C} = ( \begin{matrix}{\underline{c}}_{0} & {\underline{c}}_{1}\end{matrix} ) = ( \begin{matrix}{c}_{0 , 0} & {c}_{0 , 1} \\ {c}_{1 , 0} & {c}_{1 , 1}\end{matrix} ) = ( \begin{matrix}0 & + 1 \\ 1 & - 1\end{matrix} ) . \qquad ( Eq . 31 )$$

The representation of these weighting factors now only requires two bits in each case.

With an interpolation factor N and a chain of K integrate-and-dump filters and a recursive order of K implemented, the number of guard bits to be additionally provided by the dynamic range of the integration can be expressed as follows:

$$D ( K , N ) = ⌈ {log}_{2} \{ {h}_{INT}^{K} ( N - 1 \} ⌉ = ⌈ {log}_{2} ( \begin{matrix}N - 1 + K - 1 \\ K - 1\end{matrix} ) ⌉$$

where the guard bits specify the increase in word width per integrate-and-dump filter unit. For N=32 and K=8, for example, D (N, K)=18 guard bits are obtained which, according to the invention, can be compensated for by eight shifting devices.

The present invention supplies digital filters which are suitable for sampling rate conversion and can implement virtually any impulse response functions. The necessary accuracy for implementing a target impulse response function can be selected at virtually any level by a simple determination of weighting coefficients. In addition, various improvements supply particularly advantageous embodiments, the implementation expenditure of which is low because many weighting coefficients can be set to zero. Using, for example, integrate-and-dump filters results in only a moderate increase in guard bits in comparison with conventional integration filters. A particular advantage of the filters according to the invention consists in that sampling rate conversion is implemented by means of only a single filter stage whereas, according to the prior art, variously arranged filters must be provided in various interpolation or decimation stages in order to achieve a predetermined sampling rate conversion factor.

1. A digital filter for converting a digital input signal into a digital output signal, comprising:
an input;
an output;
a plurality of filter units each realizing mutually independent filter functions with a predetermined recursive filter order on a signal path between the input and the output and operating at a first clock rate; each of the filter units comprising at least one delay element which can be reset to a predeterminable value;
a plurality of sampling devices operating at the first clock rate; wherein to each of the filter units one of the plurality of sampling devices is allocated which sets the respective at least one resettable delay element to a predetermined value in dependence on a sampling rate conversion factor N; and
a weighting network comprising weighting coefficients, coupled to the sampling devices, and operating at a second clock rate; wherein a digital input signal of the digital filter is conducted, via the weighting network, to a respective sampling device, or wherein digital internal sampling signals output by a respective sampling device are conducted to the output of the digital filter via the weighting network.

2. The filter of claim 1, wherein the filter units have mutually orthogonal filter functions;
wherein the filter units realize Chebyshev, Butterworth or Bessel filter functions; or
wherein at least one of the filter units is constructed as an integrate-and-dump filter.

3. The filter of claim 2, wherein the filter unit constructed as an integrate-and-dump filter comprises a number of resettable delay elements, which number corresponds to the predetermined recursive order; the plurality of delay elements being interconnected with feedback as an integrator device and the associated sampling device generating a reset signal for the delay elements;
wherein the filter unit constructed as an integrate-and-dump filter comprises a single delay element with feedback;
wherein the filter units constructed as integrate-and-dump filters are combined to form an integrator stage, wherein a number, corresponding to a maximum predetermined recursive order, of resettable delay elements with individual feedback are provided which are series-interconnected with one another, and wherein in each case one associated sampling device is coupled to an input of the respective delay element with feedback and resets the latter; or
wherein the filter unit constructed as an integrate-and-dump filter has the following filter function:
$${H}_{DI}^{k , N} ( z ) = {\sum }_{n = 0}^{N - 1} ( \begin{matrix}n + k - 1 \\ K - 1\end{matrix} ) {z}^{- n}$$
wherein k is the recursive order of the filter unit and N is the sampling rate conversion factor.

4. The filter of claim 3, wherein the output of each resettable delay element with feedback is followed by a shifting device shifting a respective digital signal by a predetermined number of bits;
wherein the output of each filter unit is followed by a shifting device shifting a respective digital signal by a predetermined number of bits; or
wherein the number of sampling devices corresponds to a predetermined approximation filter order K by means of which the digital filter implements a target filter function.

5. The filter of claim 1, being constructed as an interpolation filter, wherein
the weighting network comprises a delay element chain of series-connected delay elements; the weighting network being coupled to the input of the filter and delayed internal signals can be picked up at nodes of the delay element chain; and wherein
the weighting network generates precharge signals for the sampling devices such that a respective precharge signal corresponds to a sum of the delayed internal signals weighted with weighting coefficients.

6. The filter of claim 5, wherein the resettable delay elements are in each case reset to a value corresponding to the precharge signal by the associated sampling device with an Nth clock pulse.

7. The filter of claim 5, wherein the delay element chain comprises a number of delay elements which corresponds to a maximum predetermined recursive filter order.

8. The filter of claim 5, wherein a multiplier and an adder is allocated to each weighting coefficient which is not equal to zero.

9. The filter of claim 5, approximating a target filter function with a length of L interpolation points; the number S of the series-connected delay elements of the delay element chain being
$$S = [ \frac{L}{N} ] ;$$
or having a symmetric FIR filter function, further filter units being coupled to the weighting network via further sampling devices are provided.

10. The filter of claim 5, having a symmetric FIR filter function, wherein the number S of the series-connected delay elements of the delay element
$$chain is S = [ \frac{L}{2 N} ] .$$

11. The filter of claim 1, being constructed as a decimation filter, wherein
the weighting network comprises a delay element chain of series-connected delay elements; the weighting network being coupled to the output of the filter and nodes being provided between the delay elements of the delay element chain; and wherein
the weighting network generates segment signals for the nodes of the delay element chain such that a respective segment signal corresponds to a sum of the internal sampling signals weighted with weighting coefficients.

12. The filter of claim 11, wherein the resettable delay elements are reset to zero by the associated sampling device with an Nth clock pulse.

13. The filter of claim 11, wherein the delay element chain comprises a number of delay elements which corresponds to a maximum predetermined recursive filter order.

14. The filter of claim 11, wherein a multiplier and an adder is allocated to each weighting coefficient which is not equal to zero.

15. The filter of claim 11, approximating a target filter function with a length of L interpolation points: the number S of the series-connected delay elements of the delay element chain being
$$S = [ \frac{L}{N} ] ;$$
or
having a symmetric FIR filter function, further filter units being coupled to the weighting network via further sampling devices are provided.

16. The filter of claim 11, having a symmetric FIR filter function, wherein the number S of the series-connected delay elements of the delay element chain is
$$S = [ \frac{L}{2 N} ] .$$

17. The filter of claim 9, wherein the weighting network generates further precharge signals for the further sampling devices such that a respective further precharge signal corresponds to the sum of the delayed internal signals weighted with weighting coefficients, wherein a respective weighted delayed internal signal is delayed in dependence on the delay on the internal delayed signal before the summation; or
wherein a further delay element chain with series-interconnected delay elements is allocated to each further sampling device and a respective further precharge signal can be picked up at the delay element chain and wherein the input of each delay element of the respective further delay element chain is supplied with an internal delayed signal weighted with a respective weighting coefficient.

18. The filter of claim 17, wherein the further sampling devices are coupled to a further integrator stage, the output of which is followed by a time reverser, and wherein an adder is provided which adds the output signals of the integrator stages and outputs them as the digital output signal of the filter.

19. The filter of claim 15, wherein the weighting network generates the segment signals such that a respective segment signal corresponds to the sum of the sums of the internal sampling signals, weighted with weighting coefficients, with further delayed internal sampling signals and wherein a respective further internal sampling signal generated by a further sampling device is delayed in dependence on the respective node of the delay element chain before the summation; or
wherein each further sampling device is allocated a further delay element chain with series-interconnected delay elements, to which a respective further sampling signal is supplied, and wherein delayed internal sampling signals can be picked up at outputs of the further delay elements and the segment signals are generated such that a respective segment signal corresponds to a sum of the sums, weighted with the weighting coefficients, of the respective internal sampling signals with respective delayed internal sampling signals.

20. The filter of claim 17, wherein the further sampling devices are coupled to a further integrator stage, the input of which is preceded by a time reverser to which the digital input signal of the filter is supplied.

21. The filter of claim 17, wherein the delay elements of the further delay element chain in each case generate a delay by z⁻² in the second clock rate.

22. The filter of claim 19, wherein the delay elements of the further delay element chain in each case generate a delay by z⁻² in the second clock rate.

23. A polyphase filter arrangement comprising:
a number P of filter branches each comprising a digital filter according to claim 1;
a switching device which couples a digital polyphase filter input signal into the filter branches in each case time delayed as branch signal; and
a summing device combining the output signals of the filters to form a polyphase filter output signal.

24. The polyphase filter arrangement of claim 23, wherein each digital filters is operated with a clock rate reduced by the factor P;
wherein a weighting network which is common to the digital filters of the filter branches is provided and is operated at the second clock rate; or
wherein common sampling devices are provided for the digital filters of the filter branches.

25. The polyphase filter arrangement of claim 24, wherein the sampling devices are coupled via switches to the respective filter units or to the delay elements with feedback of the respective integrator devices.

26. The polyphase filter arrangement of claim 24, constructed as an interpolation filter, wherein:
a group of P series-interconnected delay elements is allocated to each filter branch;
a respective branch signal can be picked up at respective nodes between the delay elements of a group; and
the groups are connected in series with one another to one input of the polyphase filter arrangement.

27. The polyphase filter arrangement of claim 24, constructed as a decimation filter, wherein:
a group of P series-interconnected delay elements is allocated to each filter branch;
the segment signals are supplied to a respective group clock pulse by clock pulse via adders provided between the delay elements; and
the groups are series-connected to one another at an output of the polyphase filter arrangement.

28. The polyphase filter arrangement of claim 24, constructed as an interpolation filter, wherein:
a group of P series-interconnected delay elements is allocated to each filter branch;
a respective branch signal can be picked up at respective nodes between the delay elements of a group; and
the groups are connected in series with one another to one input of the polyphase filter arrangement.

29. The polyphase filter arrangement of claim 24, constructed as decimation filter, wherein:
a group of P series-interconnected delay elements is allocated to each filter branch;
the segment signals are supplied to a respective group clock pulse by clock pulse via adders provided between the delay elements; and
the groups are series-connected to one another at an output of the polyphase filter arrangement.

30. A method for determining filter coefficients of a digital filter, comprising the steps of:
subdividing a target impulse response function for a digital filter into segments, wherein each segment comprises a predetermined number of interpolation points and each segment is a set of weighting coefficients allocated;
determining independent setup impulse response functions, each having a recursive filter order k and depending on a sampling rate conversion factor N; and
forming a linear combination of the setup impulse response functions for each segment; the coefficients of the linear combination corresponding to the weighting coefficients of the respective segment and the weighting coefficients being selected such that the linear combination approximates the target impulse response function in the respective segment.

31. The method of claim 30, comprising determining the weighting coefficients
by means of a balancing calculation;
by interpolation;
by means of a least square method; or
in accordance with the following system of equations:
$${\underbrace{( \begin{matrix}{h}_{e \cdot N + 0} \\ {h}_{e \cdot N + 1} \\ ⋮ \\ {h}_{e \cdot N + N - 1}\end{matrix} )}}_{\underline{h}} = \underbrace{( \begin{matrix}{w}_{0 , 1} & {w}_{0 , 2} & ⋯ & {w}_{0 , K} \\ {w}_{1 , 1} & {w}_{1 , 2} & ⋯ & {w}_{1 , K} \\ ⋮ & ⋮ & ⋰ & ⋮ \\ {w}_{N - 1 , 1} & {w}_{N - 1 , 2} & ⋯ & {w}_{N - 1 , K}\end{matrix} )} \cdot \underbrace{( \begin{matrix}{C}_{e , 0} \\ {C}_{e , 1} \\ ⋮ \\ {C}_{e , K - 1}\end{matrix} )}$$
wherein h is an interpolation point vector, c is a weighting coefficient vector, and W is a setup impulse response matrix, with:
$${w}_{B , K} = ( \begin{matrix}n + K = 1 \\ K = 1\end{matrix} )$$

32. The method of claim 30, wherein the setup impulse response functions correspond to integrate-and-dump filters having a recursive order k and a reset period of N.

33. The method of claim 32, wherein a respective independent setup impulse response function is:
$${H}_{DI}^{k , N} ( z ) = {\sum }_{n = 0}^{N - 1} ( \begin{matrix}n + k - 1 \\ K - 1\end{matrix} ) {z}^{- n} .$$
wherein K corresponds to a predetermined maximum recursive filter order.

34. The method of claim 30, wherein the target impulse response function has a length L and the number S of segments is
$$S = [ \frac{L}{N} ] ;$$
or
wherein the target impulse response function is selected to be symmetric and the weighting coefficients are determined such that one pair of weighting coefficients in each case has the same value.

35. The method of claim 30, wherein the number of interpolation points corresponds to the sampling rate conversion factor N.

36. The method of claim 30, comprising determining the weighting coefficients for a digital filter according to claim 1, wherein the filter units have filter functions proportional to the setup impulse response functions and a respective delayed internal signal or a respective segment signal is allocated to a segment.

37. A method for designing a digital filter according to claim 1, comprising the steps of:
determining a target impulse response function, a maximum recursive filter order K, the sampling rate conversion factor N, and a number of segments S;
determining the weighting coefficients according to a method according to claim 30;
forming a digital filter with the weighting network, wherein a multiplier and an adder is provided for each weighting coefficient which is not equal to zero, and wherein filter units implementing the respective setup impulse response functions are provided.

38. The method of claim 37, wherein the maximum recursive filter order is selected such that a maximum deviation of the implemented filter impulse response function from the target impulse response function is below a predetermined tolerance threshold.

39. The method of claim 37, wherein the step of determining the independent setup impulse response functions for at least one segment comprises:
determining a trial set of weighting coefficients, in which at least one of the K weighting coefficients is set to zero,
determining the weighting coefficients of the set of total weighting coefficients which are not set to zero in such a manner that the linear combination approximates the target impulse response function in the respective segment; and
determining a respective maximum deviation of the filter impulse response function, implemented by means of the trial set of weighting coefficients, from the target impulse response function in the segment.

40. The method of claim 39, wherein such a number of trial sets of weighting coefficients is determined that the respective maximum deviation is determined for all combinations of weighting coefficients set to zero.

41. The method of claim 40, wherein, for implementing the weighting network, the trial sets of weighting coefficients are selected which have the highest number of weighting coefficients set to zero and wherein the maximum deviations are below a predetermined tolerance threshold.

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (caceled)

56. (canceled)

57. (canceled)

58. (canceled)

59. (canceled)

60. (canceled)

61. (canceled)

62. (canceled)

63. (canceled)
